(19) United States
(12) Patent Application Publication
(10) Pub. No.: US 2026/0281339 A1
(43) Pub. Date: Sep. 17, 2026

(54) IMAGE AND VIDEO CODING AND DECODING

(71) Applicant: CANON KABUSHIKI KAISHA, Tokyo (JP)

(72) Inventors: Guillaume LAROCHE, Cesson-Sévigné (FR); Patrice ONNO, Cesson-Sévigné (FR)

(21) Appl. No.: 19/167,788

(22) PCT Filed: Apr. 2, 2024
(86) PCT No.: PCT/EP2024/058926

§ 371 Date: Sep. 22, 2025

(30) Foreign Application Priority Data
Apr. 12, 2023 (GB) 2305373.9
Jun. 8, 2023 (GB) 2308546.7
Jan. 9, 2024 (GB) 2400304.8

(51) Int. Cl. H04N 19/119; H04N 19/172; H04N 19/176; H04N 19/96

(52) U.S. Cl. CPC H04N 19/119; H04N 19/172; H04N 19/176; H04N 19/96

(57) ABSTRACT

Improvements to the processing of partitioning data for image and video data are described. A Image data is encoded or decoded into or from a bitstream. The bitstream includes data indicating a partitioning of the image data into a plurality of blocks according to a coding tree, wherein blocks in the coding tree may be partitioned according to one or more types of split. For a current block to be decoded, a parameter indicating a maximum partitioning depth of at least one split type is obtained using at least one other parameter associated with the image data.

### FIELD OF INVENTION

The present invention relates to encoding and decoding of image and video data and particularly, but not exclusively, image and video partitioning data.

### BACKGROUND

The Joint Video Experts Team (JVET), a collaborative team formed by MPEG and ITU-T Study Group 16's VCEG, released a new video coding standard referred to as Versatile Video Coding (VVC). The goal of VVC is to provide significant improvements in compression performance over the existing HEVC standard (i.e., typically twice as much as before). The main target applications and services include—but not limited to—360-degree and high-dynamic-range (HDR) videos. Particular effectiveness was shown on ultra-high definition (UHD) video test material. Thus, we may expect compression efficiency gains well-beyond the targeted 50% for the final standard.

Since the end of the standardisation of VVC v1, JVET has launched an exploration phase by establishing an exploration software (ECM). It gathers additional tools and improvements of existing tools on top of the VVC standard to target better coding efficiency.

### SUMMARY OF INVENTION

According to an aspect of the invention, there is provided a method of encoding or decoding image data into or from a bitstream, the bitstream including data indicating a partitioning of the image data into a plurality of blocks according to a coding tree, wherein blocks in the coding tree may be partitioned according to one or more types of split, the method comprising: obtaining, for a current block to be decoded, a parameter used for partitioning a current block of the image data based on at least one other parameter for partitioning the image data.

According to a further aspect of the invention, there is provided a method of encoding or decoding image data into or from a bitstream, the bitstream including data indicating a partitioning of the image data into a plurality of blocks according to a coding tree, wherein blocks in the coding tree may be partitioned according to one or more types of split, the method comprising: obtaining, for a current block to be decoded, a parameter indicating a maximum partitioning depth of at least one split type using at least one other parameter associated with the image data.

Advantages include an increase of coding efficiency and possibly an encoder run time reduction as a result of an encoder complexity reduction.

The maximum partitioning depth may be a maximum multi-tree partitioning depth indicating a maximum partitioning depth for a plurality of split types.

The at least one other parameter is optionally obtained based on another parameter for the current block.

The maximum partitioning depth may indicate a maximum multi-tree partitioning depth that indicates the maximum partitioning depth for a binary tree split and a ternary tree split.

The at least one other parameter is based on a quad-tree depth of the current block or the block size of the current block.

The obtained maximum multi-tree partitioning depth is optionally further based on a comparison of the parameter with a reference value. The reference value may be signalled in a header of the bitstream. The reference value may be based on a depth other than the quad tree depth of the current block.

The reference value may relate to a quad tree depth value associated with at least one area of another frame.

The reference value may be based on an average quad tree depth determined from the at least one area of another frame.

The reference value may be based on a minimum quad tree depth determined from the at least one area of another frame.

The reference value may be based on a maximum multi-tree depth or an average multi-tree depth determined from at least one area of another frame.

The method may include increasing a current maximum multi-tree depth to obtain the maximum multi-tree depth for the current block according to one or more rules or conditions based on the quad-tree depth value and the reference depth value.

For example, when the quad-tree depth value matches the reference quad tree depth value, increasing the current maximum multi tree depth to obtain the maximum multi tree depth for the current block.

Alternatively, or additionally, when the quad-tree depth value matches the reference value minus 1, increasing the current maximum multi tree depth to obtain the maximum multi tree depth for the current block.

Optionally, it is additionally required that the reference quad tree value matches a minimum quad tree value associated with an area of one or more reference frames for the current maximum multi tree depth to be increased.

Optionally, it is additionally required that the reference quad tree value matches the maximum quad tree depth for the current frame for the current maximum multi tree depth to be increased. The method may additionally or alternatively include decreasing a current maximum multi-tree depth to obtain the maximum multi-tree depth for the current block according to one or more rules or conditions based on the quad-tree depth value and the reference depth value.

For example, when the quad-tree depth value does not match the reference quad tree depth value, decreasing the current maximum multi tree depth to obtain the maximum multi tree depth for the current block.

Alternatively or additionally when the quad-tree depth value does not match the reference quad tree depth value minus 1, the current maximum multi-tree depth is decreased to obtain the maximum multi-tree depth for the current block.

Optionally, when the quad-tree depth value is greater than the reference depth value, the current maximum multi tree depth is decreased for the current block.

Optionally, the decreasing of the current maximum multi tree depth for the current block when the quad-tree depth value is greater than the reference depth value is only applied when the reference depth value is obtained from an area of another frame code with a higher quality than the current frame.

Optionally, when the quad-tree depth value is less than the reference depth value minus an offset, decreasing the current maximum multi tree depth for the current block. The offset may be one.

Optionally, the decreasing the current maximum multi tree depth for the current block when the quad-tree depth value is less than the reference depth value minus an offset is applied only when the reference depth value is obtained from an area of another frame code with a lower quality than the current frame.

Optionally, when the reference depth value is less than the quad tree depth value, decreasing the current maximum multi tree depth for the current block.

The quad tree depth value may be a quad tree depth value for the current frame.

Optionally, in a case where the maximum multi tree depth is decreased, the maximum multi tree depth is set to zero.

Obtaining the maximum multi-tree depth for the current block may comprise using a function of the quad-tree depth value and reference quad tree depth value.

For example, the function may be any one of:

$$MaxMttDepth = 2 * QTDepthTempo - QTDepth + 1 , \\ MaxMttDepth = min ( 2 * QTDepthTempo - QTDepth + 1 , MaxMttDepth ) , \\ and \\ MaxMttDepth = min ( QTDepth - ( QTDepthTempo - 2 ) + 1 , MaxMttDepth + 1 ) ,$$

wherein MaxMttDepth is the maximum multi-tree depth, QTDepth is the quad-tree depth of the current block and QTDepthTempo is the reference quad-tree depth value.

A maximum multi-tree depth value associated with one or more areas of another frame may be used to obtain the maximum multi-tree depth for the current block.

A condition for adjusting (modifying) the current maximum multi-tree depth to obtain the maximum multi-tree depth for the current block may be based on a comparison between a maximum multi-tree depth signalled in the bitstream and the maximum multi-tree depth value associated with one or more areas of another frame. A current maximum multi tree depth of the current block may be incremented when the maximum multi-tree depth signalled in the bitstream is less than the maximum multi-tree depth value associated with one or more areas of another frame.

The increase of the current maximum multi-tree depth of the current block may be dependent on the average multi-tree depth value associated with one or more areas of another frame. The increase may be based on a comparison between the average multi-tree depth value associated with one or more areas of another frame and the maximum multi-tree depth signalled in the bitstream.

For example, the current maximum multi-tree depth of the current block is increased if the average multi-tree depth value associated with one or more areas of another frame is greater than or equal to half of the maximum multi-tree depth for the current frame.

Optionally, the current maximum multi-tree depth of the current block is increased if the average multi-tree depth value associated with one or more areas of another frame is greater than half of the maximum multi-tree depth for the current frame.

The increase may be based on a comparison between the average multi-tree depth value associated with one or more areas of another frame and the maximum multi-tree depth of another frame.

For example, the current maximum multi-tree depth of the current block may be increased if the average multi-tree depth value associated with one or more areas of another frame is greater than or equal to half of the maximum multi-tree depth of another frame.

Optionally, the current maximum multi-tree depth of the current block may be increased if the average multi-tree depth value associated with one or more areas of another frame is greater than half of the maximum multi-tree depth of another frame.

The current maximum multi-tree depth of the current block may not be increased if the average multi-tree depth value associated with one or more areas of another frame is equal to the maximum multi-tree depth signalled in the bitstream.

Optionally, the current maximum multi-tree depth of the current block may not be increased if the average multi-tree depth value associated with one or more areas of another frame is equal to the maximum multi-tree depth of another frame.

Optionally, when the quad-tree depth value matches the reference quad tree depth value the current maximum multi-tree depth of the current block is increased.

Optionally, when the quad-tree depth value matches the reference quad tree depth value minus 1, increasing the current maximum multi-tree depth of the current block if the average multi-tree depth value associated with one or more areas of another frame is equal to half of the maximum multi-tree depth for the current frame.

Optionally, when the quad-tree depth value matches the reference quad tree depth value minus 1, increasing the current maximum multi-tree depth of the current block if the average multi-tree depth value associated with one or more areas of another frame is less than or equal to half of the maximum multi-tree depth for the current frame.

Optionally, when the quad-tree depth value matches the reference quad tree depth value minus 1, increasing the current maximum multi-tree depth of the current block if the average multi-tree depth value associated with one or more areas of another frame is less than half of the maximum multi-tree depth for the current frame.

The maximum multi-tree depth for the current frame may be halved by dividing by 2 or bit-shifting to the right by 1 bit. An offset may be added to the maximum multi-tree depth for the current frame before bit-shifting to the right.

Optionally, when the quad-tree depth value matches the reference quad tree depth value minus 1, increasing the current maximum multi-tree depth of the current block if the average multi-tree depth value associated with one or more areas of another frame is equal to half of the maximum multi-tree depth of another frame.

Optionally, when the quad-tree depth value matches the reference quad tree depth value minus 1, increasing the current maximum multi-tree depth of the current block if the average multi-tree depth value associated with one or more areas of another frame is less than or equal to half of the maximum multi-tree depth of another frame.

Optionally, when the quad-tree depth value matches the reference quad tree depth value minus 1, increasing the current maximum multi-tree depth of the current block if the average multi-tree depth value associated with one or more areas of another frame is less than half of the maximum multi-tree depth of another frame.

The maximum multi-tree depth of another frame may be halved by dividing by 2 or by bit-shifting to the right by 1 bit. An offset may be added to the maximum multi-tree depth of another frame before bit-shifting to the right.

A current maximum multi tree depth of the current block may be decreased when (based on) the maximum multi-tree depth signalled in the bitstream (being) is greater than the maximum multi-tree depth value associated with one or more areas of another frame.

A current maximum multi tree depth of the current block may be decreased when the maximum multi-tree depth signalled in the bitstream is greater than the maximum multi-tree depth value associated with one or more areas of another frame and when the current quantization parameter associated to the current block is greater than or equal to (or alternatively, greater than) the current quantization parameter associated to one or more areas of another frame.

A current maximum multi tree depth of the current block may be decreased when the maximum multi-tree depth for the current frame matches the maximum multi-tree depth value associated with one or more areas of another frame.

An additional condition for the decrement of the current maximum multi tree depth of the current block may include that the maximum multi tree depth for the current frame matches the maximum multi tree depth of another frame.

An additional criterion for the decrement of the current maximum multi tree depth to be performed is one or more of: i) the sequence including the current frame has a resolution higher than a predetermined resolution, ii) the CTU size for the current block is greater than or equal to a predetermined value, iii) the maximum multi tree depth for the current frame is less than the maximum quad tree depth of the current frame, and iv) the maximum quad tree depth for the current frame is greater than a predetermined value.

The current maximum multi tree depth of the current block may be further decreased if the current maximum multi tree depth is greater than the maximum multi-tree depth value associated with one or more areas of another frame.

The current maximum multi tree depth of the current block may be decreased when the current maximum multi tree depth is set equal to the maximum multi-tree depth value associated with one or more areas of another frame.

A current maximum multi tree depth of the current block may be increased when the maximum multi-tree depth signalled in the bitstream is equal to the maximum multi-tree depth value associated with one or more areas of another frame.

The condition for adjusting the current maximum multi-tree depth to obtain the maximum multi-tree depth for the current block based on a comparison between a maximum multi-tree depth signalled in the bitstream and the maximum multi-tree depth value associated with one or more areas of another frame may be a first condition, and a condition based on a comparison of the quad tree depth value with a reference value may be a second condition, and optionally the adjustment of the current maximum multi-tree depth is applied (e.g. and otherwise not applied) when at least both of the first and second conditions are satisfied.

A third condition may be that a maximum multi-tree depth signalled at a higher level from another frame is less than a maximum multi-tree depth signalled at a higher level for the frame of the current block, and the adjustment of the maximum multi-tree depth is optionally not performed if the third condition is not satisfied.

The third condition may be that a maximum multi-tree depth signalled at a higher level from another frame is less than or equal to a maximum multi-tree depth signalled at a higher level for the frame of the current block.

Optionally, the third condition is only considered when the coding tree unit size for the current block is 256.

The higher level may be any one of a slice, picture or sequence level and optionally is signalled in a header.

The modifying of the maximum multi-tree depth may be disabled if the image data contains screen content.

The image data is deemed to contain screen content if a number of blocks are encoded using a palette mode in an area of the current frame or one or more areas of another frame crosses a threshold value (is greater than or less than a predetermined value) and/or whether a palette mode is enabled in the bitstream.

The or one area of another frame may be an area that is collocated with the current block.

The or one area another frame may comprise a plurality of blocks at different positions.

The or one area of another frame may be an area having a greater size than the current block.

The or one area of another frame having a greater size than the current block may be a coding tree unit, CTU.

The center position of the current block may be used to determine the or one area in another frame.

The or one area may encompasses an entire area of a reference frame.

The another frame may be a frame with a same temporal ID as the current frame that includes the current block.

The frame with the same temporal ID may be the closest frame with a same temporal ID.

The another frame may be a frame with a same quantization parameter as the current frame that includes the current block.

The another frame may be a frame that is used for temporal motion vector prediction.

The another frame may be a frame which is the closest reference frame to the current frame that includes the current block.

The one or more areas may include a first area from a first another frame and a second area from a second another frame.

The another frame may be a frame corresponding to an intra frame.

The method may comprise modifying a current maximum multi-tree depth to obtain the maximum multi-tree depth for the current block according to one or more rules or conditions based on the quad-tree depth value and the reference (quad-tree) depth value associated with the intra frame.

For example, when the quad-tree depth value matches the reference quad tree depth value associated with the intra frame, increasing the current maximum multi tree depth to obtain the maximum multi tree depth for the current block.

Optionally, not increasing the current maximum multi tree depth to obtain the maximum multi tree depth for the current block when the quad-tree depth value matches the reference quad tree depth value minus 1.

Optionally, when the quad-tree depth value matches the reference quad tree depth value minus 1, decreasing the current maximum multi tree depth to obtain the maximum multi tree depth for the current block.

The method may comprise a further condition for modifying the current maximum multi-tree depth to obtain the maximum multi-tree depth for the current block which may be based on a comparison between a maximum multi-tree depth signalled in the bitstream and a reference maximum multi-tree depth value associated with one or more areas of the intra frame.

For example, decreasing a current maximum multi tree depth of the current block when (based on) the maximum multi-tree depth signalled in the bitstream is (being) less than the reference maximum multi-tree depth value associated with one or more areas of the intra frame. The method may comprise a further condition for modifying the current maximum multi-tree depth to obtain the maximum multi-tree depth for the current block is based on a comparison between a maximum multi-tree depth signalled in the bitstream and the maximum multi-tree depth of the intra frame.

For example, decreasing a current maximum multi tree depth of the current block when (based on) the maximum multi-tree depth signalled in the bitstream is (being) less than the maximum multi-tree depth of the intra frame.

The method may further comprise modifying a current maximum multi-tree depth to obtain the maximum multi-tree depth for the current block based on a comparison between a reference average multi-tree depth value associated with one or more areas of the intra frame and the maximum multi-tree depth of the intra frame.

For example, the current maximum multi-tree depth of the current block may be decreased if the reference average multi-tree depth value associated with one or more areas of the intra frame is greater than or equal to the maximum multi-tree depth of the intra frame.

Optionally, the current maximum multi-tree depth of the current block may be decreased if the reference average multi-tree depth value associated with one or more areas of the intra frame is equal to the maximum multi-tree depth of the intra frame.

The method may further comprise modifying a current maximum multi-tree depth to obtain the maximum multi-tree depth for the current block based on a comparison between a reference average multi-tree depth value associated with one or more areas of the intra frame and the maximum multi-tree depth value associated with one or more areas of the intra frame.

For example, the current maximum multi-tree depth of the current block may be decreased if the reference average multi-tree depth value associated with one or more areas of the intra frame is greater than or equal to the maximum multi-tree depth value associated with one or more areas of the intra frame.

Optionally, the current maximum multi-tree depth of the current block may be decreased if the reference average multi-tree depth value associated with one or more areas of the intra frame is equal to the maximum multi-tree depth value associated with one or more areas of the intra frame.

Optionally, when the quad-tree depth value matches the reference quad tree depth value minus 1, increasing the current maximum multi tree depth to obtain the maximum multi tree depth for the current block based on a comparison of the maximum multi-tree depth signalled in the bitstream with a maximum multi-tree depth of the intra frame, and a reference maximum multi-tree depth value associated with one or more areas of the intra frame.

For example, the current maximum multi tree depth is increased when the maximum multi-tree depth signalled in the bitstream is equal to the maximum multi-tree depth of the intra frame and the maximum multi-tree depth signalled in the bitstream is less than the reference maximum multi-tree depth value associated with one or more areas of the intra frame.

Optionally, when the quad-tree depth value matches the reference quad tree depth value minus 1, increasing the current maximum multi tree depth to obtain the maximum multi tree depth for the current block based on a comparison of a reference average multi-tree depth value associated with one or more areas of the intra frame with a maximum multi-tree depth of the intra frame.

For example, the current maximum multi tree depth is increased when the reference average multi-tree depth value associated with one or more areas of the intra frame is equal to the maximum multi-tree depth of the intra frame.

Optionally, the current maximum multi tree depth is increased when the reference average multi-tree depth value associated with one or more areas of the intra frame is less than or equal to the maximum multi-tree depth of the intra frame.

Optionally, when the quad-tree depth value matches the reference quad tree depth value minus 1, increasing the current maximum multi tree depth to obtain the maximum multi tree depth for the current block based on a comparison of a reference average multi-tree depth value associated with one or more areas of the intra frame with a reference maximum multi-tree depth value associated with one or more areas of the intra frame.

For example, the current maximum multi tree depth is increased when the reference average multi-tree depth value associated with one or more areas of the intra frame is equal to the reference maximum multi-tree depth value associated with one or more areas of the intra frame.

Optionally, the current maximum multi tree depth is increased when the reference average multi-tree depth value associated with one or more areas of the intra frame is less than or equal to reference maximum multi-tree depth value associated with one or more areas of the intra frame.

The current maximum multi tree depth may be increased when all inter frames in the sequence including the current frame have the same maximum multi tree depth.

A current maximum multi-tree depth may not be increased when another frame corresponds to an intra frame according to one or more rules or conditions.

For example, the current maximum multi-tree depth is not increased when the intra frame has a different temporal ID to the current frame that includes the current block.

Alternatively, or additionally, the current maximum multi-tree depth is not increased when a picture order count (POC) difference between the current frame and the intra frame is less than a threshold. The threshold may correspond to a POC difference between the current frame and the intra frame being equal to 2 or 3.

Optionally, when another frame is a frame that is used for temporal motion vector prediction a current maximum multi-tree depth is modified according to one or more rules or conditions.

For example, the current maximum multi-tree depth is increased when a picture order count (POC) difference between the current frame and the frame that is used for temporal motion vector prediction is less than or equal to 2.

Optionally, the current maximum multi-tree depth is increased when the frame that is used for temporal motion vector prediction is a frame with a different temporal ID to the current frame that includes the current block.

Optionally, the current maximum multi-tree depth is not increased when a quantization parameter for the sequence including the current frame is greater than or equal to 22.

A plurality of maximum multi-tree depth values may be signalled in the bitstream and obtaining the maximum multi-tree depth for the current block comprises determining one of the signalled values as the maximum multi-tree depth for the current block.

The plurality of maximum multi-tree depth values may be signalled in one or more of a sequence parameter set, a picture parameter set, a picture header and a slice header.

A plurality of maximum multi-tree depth values may be associated with a quad-tree depth or block size.

At least one of the plurality of maximum multi-tree depth values may be obtained by predicting its value from another of the plurality of maximum multi-tree depth values.

The maximum multi-tree depth values are determined using a value signalled in a header or parameter set.

At least one of the plurality of maximum multi-tree depth values may be obtained by applying predetermined offsets to a default value. The default (predetermined) value may be signalled in the bitstream.

In the aspects and embodiments we refer to a binary split. Such a binary split may include horizontal binary splitting and/or vertical binary splitting. In the aspects embodiments we refer to a ternary split. Such a ternary split may include horizontal ternary splitting and/or vertical ternary splitting.

Further, although the above embodiments refer to binary tree (horizontal and vertical), ternary tree (horizontal and vertical), quad tree and no split being possible splits of a coding unit or CTU, it would be understood that the invention is not so limited and other modes may be considered. For example, other geometrical splits may be considered into different numbers of blocks and restricted according to one or more criteria mentioned in the aspects and embodiments above.

In further embodiments, the methods described above may be disabled for screen content coded image data or video data, for a low delay configuration, using at least one flag (e.g. transmitted in a header). Whether the image or video data to be encoded or decoded is screen content coded image data may be determined based on whether a number of blocks in an area of the frame including the current block or an (e.g. collocated or temporal) area of another frame which are Intra block coded or are palette mode coded crosses a threshold (is above a predetermined value or alternatively is below a predetermined value). Alternatively, whether the image or video data is screen content coded may be indicated by whether the palette mode has been enabled for the image data or video data (e.g. by the setting of a flag in a header).

Other aspects of the invention relate to corresponding, an encoding device, a decoding device, and a computer program operable to carry out the decoding and/or encoding methods of the invention.

In a further aspect according to the present invention, there is provided device for encoding image data into a bitstream, the device being configured to perform the method according to any of the aspects and embodiments mentioned above.

In another aspect according to the present invention, there is provided device for decoding image data from a bitstream, the device being configured to perform the method of any of the embodiments and aspects mentioned above.

In a yet further aspect, there is provided a computer program which is arranged to, upon execution, cause the method of any of the aspects and embodiments to be performed.

The computer program may be provided on its own or may be carried on, by or in a carrier medium. The carrier medium may be non-transitory, for example a storage medium, in particular a computer-readable storage medium. The carrier medium may also be transitory, for example a signal or other transmission medium. The signal may be transmitted via any suitable network, including the Internet. Further features of the invention are characterised by the independent and dependent claims.

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

### BRIEF DESCRIPTION OF THE DRAWINGS

Reference will now be made, by way of example, to the accompanying drawings, in which:

FIG. 1 is a diagram which illustrates a coding structure used in HEVC;

FIG. 2 is a block diagram schematically illustrating a data communication system in which one or more embodiments of the invention may be implemented;

FIG. 3 is a block diagram illustrating components of a processing device in which one or more embodiments of the invention may be implemented;

FIG. 4 is a schematic illustrating functional elements of an encoder according to embodiments of the invention;

FIG. 5 is a schematic illustrating functional elements of a decoder according to embodiments of the invention;

FIG. 6 shows blocks positioned relative to a current block including a collocated block;

FIG. 7 illustrates a temporal random-access GOP structure for 33 frames with the related Temporal ID and POC;

FIG. 8 illustrates the 6 possible split modes of VVC;

FIG. 9 illustrates the MaxBTSize and MaxMttDepth;

FIG. 10 illustrates an example of MinQTSize variable;

FIG. 11 illustrates some of partitioning constraints;

FIG. 12 illustrates incomplete CTUs in the borders of a frame;

FIG. 13 illustrates an encoding by settings of MaxMttDepth based on the temporal ID;

FIG. 14 illustrates an embodiment of the invention;

FIG. 15 illustrates several temporal positions;

FIG. 16 is a diagram showing a system comprising an encoder or a decoder and a communication network according to embodiments;

FIG. 17 is a schematic block diagram of a computing device for implementation of one or more embodiments;

FIG. 18 is a diagram illustrating a network camera system; and

FIG. 19 is a diagram illustrating a smart phone.

### DETAILED DESCRIPTION

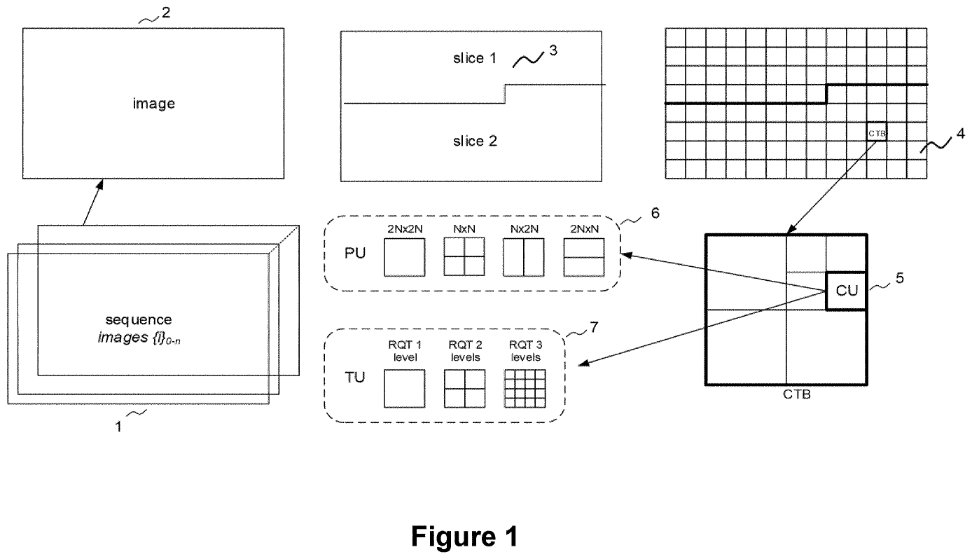

FIG. 1 relates to a coding structure used in the High Efficiency Video Coding (HEVC) video and Versatile Video Coding (VVC) standards. A video sequence 1 is made up of a succession of digital images i. Each such digital image is represented by one or more matrices. The matrix coefficients represent pixels.

An image 2 of the sequence may be divided into slices 3. A slice may in some instances constitute an entire image. These slices are divided into non-overlapping Coding Tree Units (CTUs). A Coding Tree Unit (CTU) is the basic processing unit of the High Efficiency Video Coding (HEVC) and Versatile Video Coding (VVC) video standards and conceptually corresponds in structure to macroblock units that were used in several previous video standards. A CTU is also sometimes referred to as a Largest Coding Unit (LCU). A CTU has luma and chroma component parts, each of which component parts is called a Coding Tree Block (CTB). These different color components are not shown in FIG. 1.

A CTU is generally of size 64 pixels×64 pixels for HEVC, yet for VVC this size can be 128 pixels×128 pixels. Each CTU may in turn be iteratively divided into smaller variable-size Coding Units (CUs) 5 using a quadtree (QT) decomposition.

Coding units are the elementary coding elements and are constituted by two kinds of sub-unit called a Prediction Unit (PU) and a Transform Unit (TU). The maximum size of a PU or TU is equal to the CU size. A Prediction Unit corresponds to the partition of the CU for prediction of pixels values. Various different partitions of a CU into PUs are possible as shown by 6 including a partition into 4 square PUs and two different partitions into 2 rectangular PUs. A Transform Unit is an elementary unit that is subjected to spatial transformation using DCT. A CU can be partitioned into TUs based on a quadtree representation 7.

Each slice is embedded in one Network Abstraction Layer (NAL) unit. In addition, the coding parameters of the video sequence are stored in dedicated NAL units called parameter sets. In HEVC and H.264/AVC two kinds of parameter sets NAL units are employed: first, a Sequence Parameter Set (SPS) NAL unit that gathers all parameters that are unchanged during the whole video sequence. Typically, it handles the coding profile, the size of the video frames and other parameters. Secondly, a Picture Parameter Set (PPS) NAL unit includes parameters that may change from one image (or frame) to another of a sequence. HEVC also includes a Video Parameter Set (VPS) NAL unit which contains parameters describing the overall structure of the bitstream. The VPS is a type of parameter set defined in HEVC, and applies to all of the layers of a bitstream. A layer may contain multiple temporal sub-layers, and all version 1 bitstreams are restricted to a single layer. HEVC has certain layered extensions for scalability and multiview and these will enable multiple layers, with a backwards compatible version 1 base layer.

Other ways of splitting an image have been introduced in VVC including subpictures, which are independently coded groups of one or more slices.

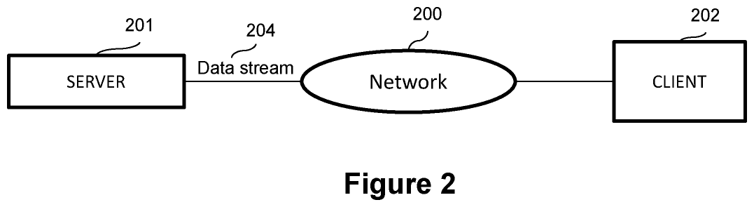

FIG. 2 illustrates a data communication system in which one or more embodiments of the invention may be implemented. The data communication system comprises a transmission device, in this case a server 201, which is operable to transmit data packets of a data stream to a receiving device, in this case a client terminal 202, via a data communication network 200. The data communication network 200 may be a Wide Area Network (WAN) or a Local Area Network (LAN). Such a network may be for example a wireless network (Wifi/802.11 a or b or g), an Ethernet network, an Internet network or a mixed network composed of several different networks. In a particular embodiment of the invention the data communication system may be a digital television broadcast system in which the server 201 sends the same data content to multiple clients.

The data stream 204 provided by the server 201 may be composed of multimedia data representing video and audio data. Audio and video data streams may, in some embodiments of the invention, be captured by the server 201 using a microphone and a camera respectively. In some embodiments data streams may be stored on the server 201 or received by the server 201 from another data provider, or generated at the server 201. The server 201 is provided with an encoder for encoding video and audio streams in particular to provide a compressed bitstream for transmission that is a more compact representation of the data presented as input to the encoder.

In order to obtain a better ratio of the quality of transmitted data to quantity of transmitted data, the compression of the video data may be for example in accordance with the HEVC format or H.264/AVC format or VVC format or the format of data generated by the ECM.

The client 202 receives the transmitted bitstream and decodes the reconstructed bitstream to reproduce video images on a display device and the audio data by a loud speaker.

Although a streaming scenario is considered in the example of FIG. 2, it will be appreciated that in some embodiments of the invention the data communication between an encoder and a decoder may be performed using for example a media storage device such as an optical disc.

In one or more embodiments of the invention a video image is transmitted with data representative of compensation offsets for application to reconstructed pixels of the image to provide filtered pixels in a final image.

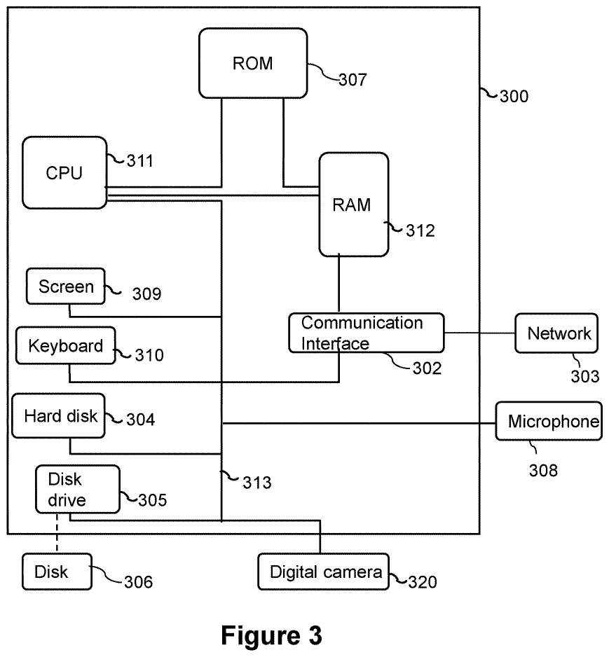

FIG. 3 schematically illustrates a processing device 300 configured to implement at least an embodiment of the present invention. The processing device 300 may be a device such as a micro-computer, a workstation or a light portable device. The device 300 comprises a communication bus 313 connected to:
a central processing unit 311, such as a microprocessor, denoted CPU;
a read only memory 306, denoted ROM, for storing computer programs for implementing the invention;
a random access memory 312, denoted RAM, for storing the executable code of the method of embodiments of the invention as well as the registers adapted to record variables and parameters necessary for implementing the method of encoding a sequence of digital images and/or the method of decoding a bitstream according to embodiments of the invention; and
a communication interface 302 connected to a communication network 303 over which digital data to be processed are transmitted or received

Optionally, the apparatus 300 may also include the following components:
a data storage means 304 such as a hard disk, for storing computer programs for implementing methods of one or more embodiments of the invention and data used or produced during the implementation of one or more embodiments of the invention;
a disk drive 305 for a disk 306, the disk drive being adapted to read data from the disk 306 or to write data onto said disk;
a screen 309 for displaying data and/or serving as a graphical interface with the user, by means of a keyboard 310 or any other pointing means.

The apparatus 300 can be connected to various peripherals, such as for example a digital camera 320 or a microphone 308, each being connected to an input/output card (not shown) so as to supply multimedia data to the apparatus 300.

The communication bus provides communication and interoperability between the various elements included in the apparatus 300 or connected to it. The representation of the bus is not limiting and in particular the central processing unit is operable to communicate instructions to any element of the apparatus 300 directly or by means of another element of the apparatus 300.

The disk 306 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in read only memory 306, on the hard disk 304 or on a removable digital medium such as for example a disk 306 as described previously. According to a variant, the executable code of the programs can be received by means of the communication network 303, via the interface 302, in order to be stored in one of the storage means of the apparatus 300 before being executed, such as the hard disk 304.

The central processing unit 311 is adapted to control and direct the execution of the instructions or portions of software code of the program or programs according to the invention, instructions that are stored in one of the aforementioned storage means. On powering up, the program or programs that are stored in a non-volatile memory, for example on the hard disk 304 or in the read only memory 306, are transferred into the random access memory 312, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

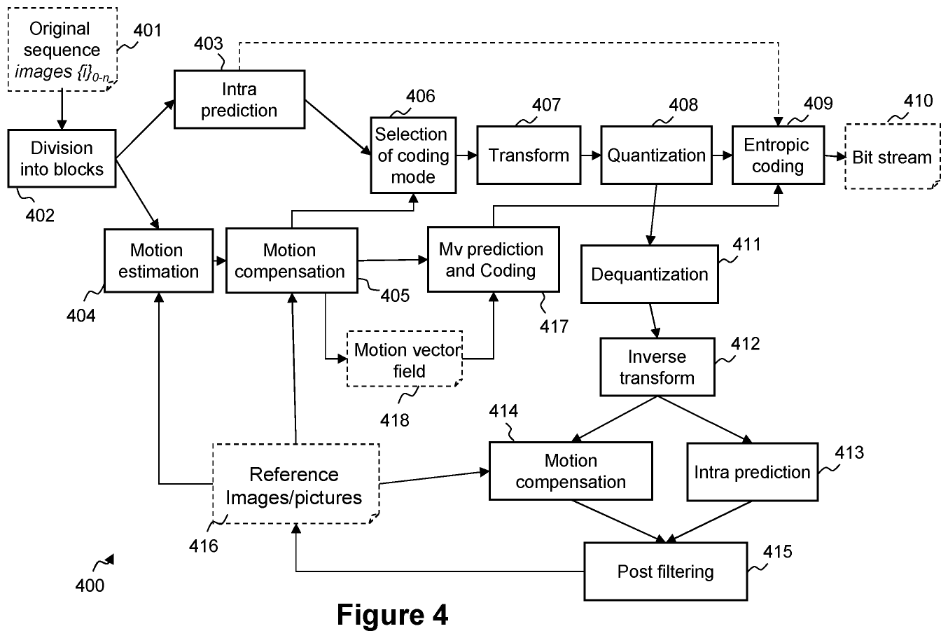

FIG. 4 illustrates a block diagram of an encoder according to at least an embodiment of the invention. The encoder is represented by connected modules, each module being adapted to implement, for example in the form of programming instructions to be executed by the CPU 311 of device 300, at least one corresponding step of a method implementing at least an embodiment of encoding an image of a sequence of images according to one or more embodiments of the invention.

An original sequence of digital images i0 to in 401 is received as an input by the encoder 400. Each digital image is represented by a set of samples, sometimes also referred to as pixels (hereinafter, they are referred to as pixels).

A bitstream 410 is output by the encoder 400 after implementation of the encoding process. The bitstream 410 comprises a plurality of encoding units or slices, each slice comprising a slice header for transmitting encoding values of encoding parameters used to encode the slice and a slice body, comprising encoded video data.

The input digital images i₀ to iₙ 401 are divided into blocks of pixels by module 402. The blocks correspond to image portions and may be of variable sizes (e.g. 4×4, 8×8, 16×16, 32×32, 64×64, 128×128 pixels and several rectangular block sizes can be also considered). A coding mode is selected for each input block. Two families of coding modes are provided: coding modes based on spatial prediction coding (Intra prediction), and coding modes based on temporal prediction (Inter coding, Merge, SKIP). The possible coding modes are tested.

Module 403 implements an Intra prediction process, in which the given block to be encoded is predicted by a predictor computed from pixels of the neighbourhood of said block to be encoded. An indication of the selected Intra predictor and the difference between the given block and its predictor is encoded to provide a residual if the Intra coding is selected.

Temporal prediction is implemented by motion estimation module 404 and motion compensation module 405. Firstly, a reference image from among a set of reference images 416 is selected, and a portion of the reference image, also called reference area or image portion, which is the closest area (closest in terms of pixel value similarity) to the given block to be encoded, is selected by the motion estimation module 404. Motion compensation module 405 then predicts the block to be encoded using the selected area. The difference between the selected reference area and the given block, also called a residual block, is computed by the motion compensation module 405. The selected reference area is indicated using a motion vector.

Thus, in both cases (spatial and temporal prediction), a residual is computed by subtracting the predictor from the original block.

In the INTRA prediction implemented by module 403, a prediction direction is encoded. In the Inter prediction implemented by modules 404, 405, 416, 418, 417, at least one motion vector or data for identifying such motion vector is encoded for the temporal prediction.

Information relevant to the motion vector and the residual block is encoded if the Inter prediction is selected. To further reduce the bitrate, assuming that motion is homogeneous, the motion vector is encoded by difference with respect to a motion vector predictor. Motion vector predictors from a set of motion information predictor candidates is obtained from the motion vectors field 418 by a motion vector prediction and coding module 417.

The encoder 400 further comprises a selection module 406 for selection of the coding mode by applying an encoding cost criterion, such as a rate-distortion criterion. In order to further reduce redundancies a transform (such as DCT) is applied by transform module 407 to the residual block, the transformed data obtained is then quantized by quantization module 408 and entropy encoded by entropy encoding module 409. Finally, the encoded residual block of the current block being encoded is inserted into the bitstream 410.

The encoder 400 also performs decoding of the encoded image in order to produce a reference image (e.g. those in Reference images/pictures 416) for the motion estimation of the subsequent images. This enables the encoder and the decoder receiving the bitstream to have the same reference frames (reconstructed images or image portions are used). The inverse quantization (“dequantization”) module 411 performs inverse quantization (“dequantization”) of the quantized data, followed by an inverse transform by inverse transform module 412. The intra prediction module 413 uses the prediction information to determine which predictor to use for a given block and the motion compensation module 414 actually adds the residual obtained by module 412 to the reference area obtained from the set of reference images 416.

Post filtering is then applied by module 415 to filter the reconstructed frame (image or image portions) of pixels. In the embodiments of the invention an SAO loop filter is used in which compensation offsets are added to the pixel values of the reconstructed pixels of the reconstructed image. It is understood that post filtering does not always have to performed. Also, any other type of post filtering may also be performed in addition to, or instead of, the SAO loop filtering.

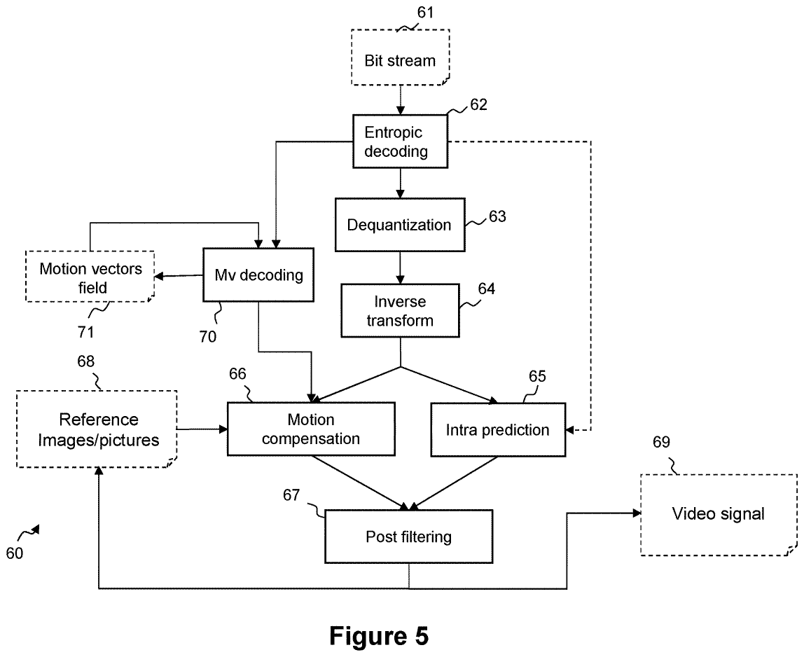

FIG. 5 illustrates a block diagram of a decoder 60 which may be used to receive data from an encoder according an embodiment of the invention. The decoder is represented by connected modules, each module being adapted to implement, for example in the form of programming instructions to be executed by the CPU 311 of device 300, a corresponding step of a method implemented by the decoder 60.

The decoder 60 receives a bitstream 61 comprising encoded units (e.g. data corresponding to a block or a coding unit), each one being composed of a header containing information on encoding parameters and a body containing the encoded video data. As explained with respect to FIG. 4, the encoded video data is entropy encoded, and the motion vector predictors' indexes are encoded, for a given block, on a predetermined number of bits. The received encoded video data is entropy decoded by module 62. The residual data are then dequantized by module 63 and then an inverse transform is applied by module 64 to obtain pixel values.

The mode data indicating the coding mode are also entropy decoded and based on the mode, an INTRA type decoding or an INTER type decoding is performed on the encoded blocks (units/sets/groups) of image data.

In the case of INTRA mode, an INTRA predictor is determined by intra prediction module 65 based on the intra prediction mode specified in the bitstream.

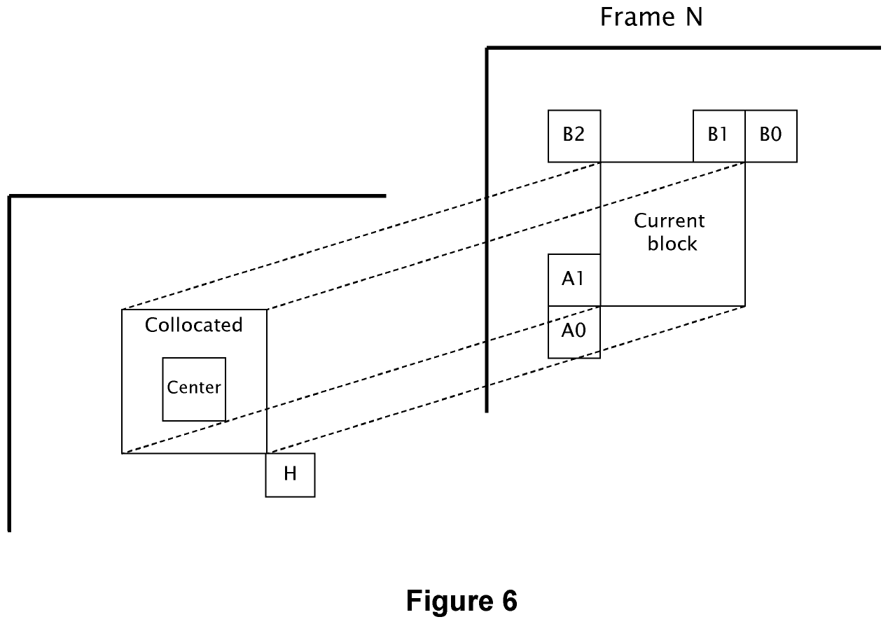

If the mode is INTER, the motion prediction information is extracted from the bitstream so as to find (identify) the reference area used by the encoder. The motion prediction information comprises the reference frame index and the motion vector residual. The motion vector predictor is added to the motion vector residual by motion vector decoding module 70 in order to obtain the motion vector. The various motion predictor tools used in VVC are discussed in more detail below with reference to FIGS. 6-10.

Motion vector decoding module 70 applies motion vector decoding for each current block encoded by motion prediction. Once an index of the motion vector predictor for the current block has been obtained, the actual value of the motion vector associated with the current block can be decoded and used to apply motion compensation by module 66. The reference image portion indicated by the decoded motion vector is extracted from a reference image 68 to apply the motion compensation 66. The motion vector field data 71 is updated with the decoded motion vector in order to be used for the prediction of subsequent decoded motion vectors.

Finally, a decoded block is obtained. Where appropriate, post filtering is applied by post filtering module 67. A decoded video signal 69 is finally obtained and provided by the decoder 60.

### Random Access Configuration

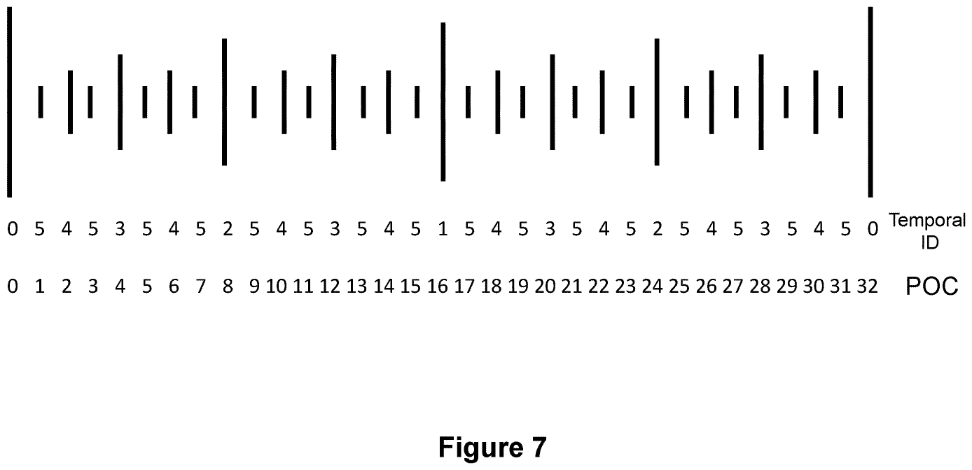

FIG. 7 shows a temporal random-access GOP structure for 33 consecutive frames 0 to 32. The length of the vertical line representing each frame corresponds their temporal ID. (e.g. the longest length corresponds temporal ID 0 and the shortest length for temporal ID 5). The frames with a temporal ID 0 are the highest in the temporal hierarchy because they can be decoded independently to all others frames with a higher temporal ID value. In the same way, the frames with a temporal ID 1 are in the second in the temporal hierarchy and they can be decoded independently to all others frames with a higher temporal ID and so on for the other temporal IDs In other words, a frame with a particular temporal ID can be decoded independently from frames with temporal IDs higher in value but may be dependent on frames with lower temporal IDs. This is what is known as temporal scalability.

This parameter is similar to the hierarchy depth but the hierarchy depth does not imply the independence decoding to all other frames with a higher depth.

### VVC Partitioning

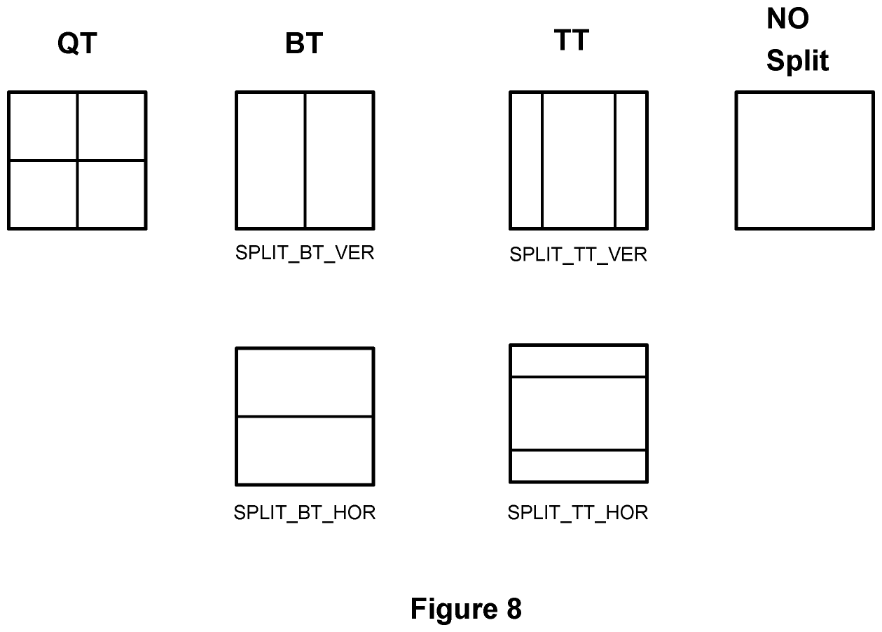

The VVC Partitioning has a specific block partitioning. For one tree node, 6 possible splits are possible as depicted in FIG. 8:
The quad split Q
The binary split BT with its two possible subdivisions 802, 803:
   the vertical binary split, 802, SPLIT_BT_VER
   the horizontal binary split, 803, SPLIT_BT_HOR
The ternary split TT with its 2 possible subdivisions 804, 805 where the block is split into 3 blocks with a larger band in the middle:
   the vertical ternary split, 804, SPLIT_TT_VER
   the horizontal ternary split, 805, SPLIT_TT_HOR
The No Split, 806, which terminates a tree node so there is no splitting.

### VVC Splitting Control Variables

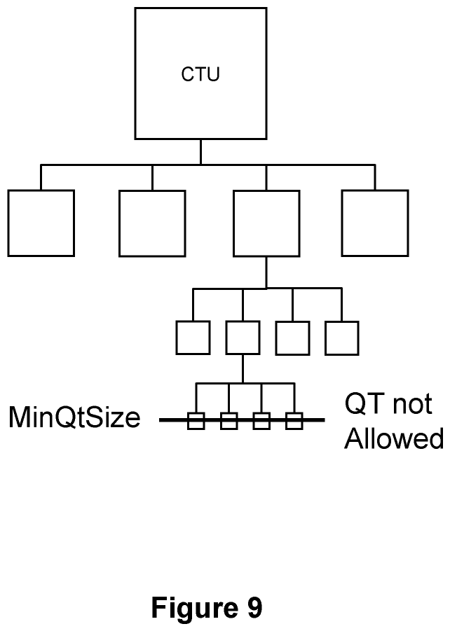

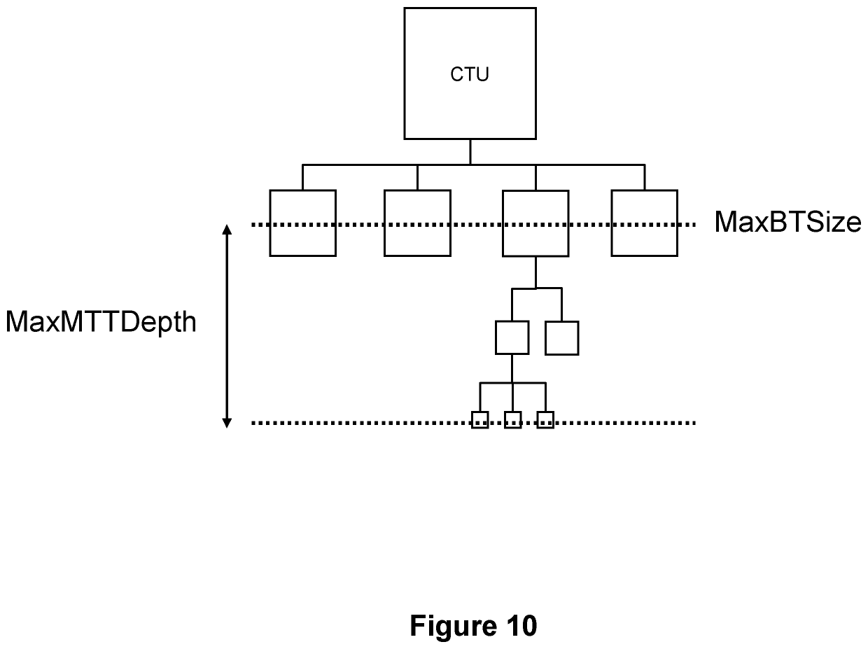

For a current block not all the possible splits are not always permitted. Which splits are available depends on several conditions. These conditions depend on several splitting control variables which have been defined. A first set of variables define the maximum and the minimum block/node size:
CTU size: it corresponds to the root node size of a quadtree (for example 256×256, 128×128, 64×64, 32×32, 16×16 luma samples);
MaxBTSize: is the maximum allowed binary tree root node size, i.e., the maximum size of a leaf quadtree node that may be partitioned by binary splitting. A current block can be split thanks to a BT split if both height and width of the current block are less than or equal to MaxBTSize. FIG. 9 illustrates the concept of MaxBTSize where the MaxBTSize is the size of the quad tree leaf nodes 902 of a CTU 901
MinBTSize: is the minimum allowed binary tree leaf node size; i.e., the minimum width or height of a binary leaf node. So, a current block can be split thanks to a horizontal BT split if its height is greater than MinBTSize. And a current block can be split thanks to a vertical BT split if its width is greater than MinBTSize.
MaxTTSize: is the maximum allowed ternary tree root node size, i.e., the maximum size of a leaf quadtree node that may be partitioned by ternary splitting. A current block can be split thanks to a TT split if both height and width of the current block are less than or equal to MaxTTSize.
MinTTSize: represents the minimum allowed ternary tree (TT) leaf node size; i.e., the minimum width or height of a binary leaf node. But in contrast to the BT Split, to be allowed a minimum TT partition size is considered. So, a current block can be split thanks to a horizontal TT split if its height is greater than twice the MinTTSize. And a current block can be split thanks to a vertical TT split if its width is strictly greater than twice times the MinTTSize.
MinQTSize: is the minimum allowed quadtree (QT) leaf node size; So, For the current block if the current block width is not greater than the MinQTSize, the QT split mode is not allowed. FIG. 10 illustrates an example of MinQTSize. By considering a CTU 128, in the illustrated example the MinQTsize is equal to 16.

There is no definition of a MaxQTSize, so it corresponds to the CTU size.

The minimum allowed block size for the width and the height is 4.

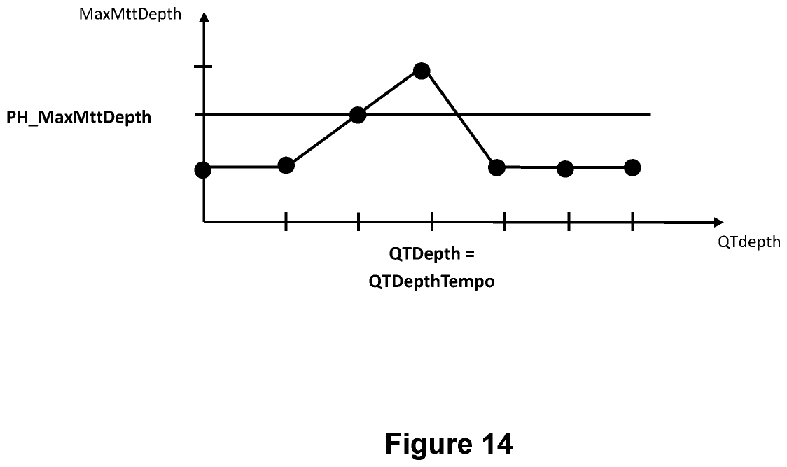

A set of depths are also defined.
Depth: is the depth in the tree. In VVC specification a leaf is a terminating node of a tree that is a root node of a tree of depth 0. It means that for each split this value is incremented (by 1).
MttDepth: it is the depth of multi tree. The multi tree includes BT splits and TT splits.
The MaxMttDepth is defined in VVC specification which is the maximum allowed multi tree depth. So, MttDepth is greater than or equal to maxMttDepth. FIG. 14 illustrates the concept of maxMttDepth.

In VVC these variables are defined independently for Luma and Chroma.

In the VTM software and ECM software, there is several other variables corresponding to depths.

The variable currBtDepth is the current number of BT splits used to reach the current tree node (or the current block). The variable currMttDepth is the current number of BT splits and TT splits used to reach the current tree node (or the current block). The variable MaxBtDepth corresponds to the variable MaxMttDepth of the VVC specification. The currQtDepth is the current number of QT splits used to reach the current tree node (or the current block).MaxltDepth: is the maximum allowed binary tree depth, i.e., the lowest level at which binary splitting may occur, where the quadtree leaf node is the root (e.g., 3).

### VVC Splitting Control Syntax Elements

To set the values of these different variables, some high-level syntax elements are transmitted in the SPS as depicted in the following table of SPS syntax elements

| | Descriptor |
|---|---|
| seq_parameter_set_rbsp( ) { | |
| ... | |
| sps_log2_min_luma_coding_block_size_minus2 | ue(v) |
| sps_partition_constraints_override_enabled_flag | u(1) |
| sps_log2_diff_min_qt_min_cb_intra_slice_luma | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_chroma_format_idc != 0 ) | |
| sps_qtbtt_dual_tree_intra_flag | u(1) |
| if( sps_qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_log2_diff_min_qt_min_cb_inter_slice | ue(v) |
| sps_max_mtt_hierarchy_depth_inter_slice | ue(v) |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| ... | |

When the sps_partition_constraints_override_enabled_flag is enabled in the SPS, some picture header syntax elements are transmitted to update the partitioning variables as depicted in the following table of PH syntax elements.

| | Descriptor |
|---|---|
| picture_header_structure( ) { | |
| ... | |
| if( sps_partition_constraints_override_enabled_flag ) | |
| ph_partition_constraints_override_flag | u(1) |
| if( ph_intra_slice_allowed_flag ) { | |
| if( ph_partition_constraints_override_flag ) { | |
| ph_log2_diff_min_qt_min_cb_intra_slice_luma | ue(v) |
| ph_max_mtt_hierarchy_depth_intra_slice_luma | ue(v) |
| if( ph_max_mtt_hierarchy_depth_intra_slice_luma != 0 ) { | |
| ph_log2_diff_max_bt_min_qt_intra_slice_luma | ue(v) |
| ph_log2_diff_max_tt_min_qt_intra_slice_luma | ue(v) |
| } | |
| if( sps_qtbtt_dual_tree_intra_flag ) { | |
| ph_log2_diff_min_qt_min_cb_intra_slice_chroma | ue(v) |
| ph_max_mtt_hierarchy_depth_intra_slice_chroma | ue(v) |
| if( ph_max_mtt_hierarchy_depth_intra_slice_chroma != 0 ) { | |
| ph_log2_diff_max_bt_min_qt_intra_slice_chroma | ue(v) |
| ph_log2_diff_max_tt_min_qt_intra_slice_chroma | ue(v) |
| } | |
| } | |
| } | |
| ... | |
| } | |
| if( ph_inter_slice_allowed_flag ) { | |
| if( ph_partition_constraints_override_flag ) { | |
| ph_log2_diff_min_qt_min_cb_inter_slice | ue(v) |
| ph_max_mtt_hierarchy_depth_inter_slice | ue(v) |
| if( ph_max_mtt_hierarchy_depth_inter_slice != 0 ) { | |
| ph_log2_diff_max_bt_min_qt_inter_slice | ue(v) |
| ph_log2_diff_max_tt_min_qt_inter_slice | ue(v) |
| } | |
| } | |
| ... | |

### VVC Coding, Split Mode

In VVC, the coding split mode are transmitted in the coding tree as depicted in the following syntax table where the conditionally parsed flags, split_cu_flag, split_qt_flag, mtt_split_cu_vertical_flag, mtt_split_cu_binary flag define the splitting of a CU.

| | Descriptor |
|---|---|
| coding_tree( x0, y0, cbWidth, cbHeight, qgOnY, qgOnC, cbSubdiv, cqtDepth, mttDepth, | |
| depthOffset, partIdx, treeTypeCurr, modeTypeCurr ) { | |
| if( ( allowSplitBtVer \|\| allowSplitBtHor \|\| allowSplitTtVer \|\| allowSplitTtHor \|\| | |
| allowSplitQt ) && ( x0 + cbWidth <= pps_pic_width_in_luma_samples ) && | |
| ( y0 + cbHeight <= pps_pic_height_in_luma_samples ) ) | |
| split_cu_flag | ae(v) |
| if( pps_cu_qp_delta_enabled_flag && qgOnY && cbSubdiv <= CuQpDeltaSubdiv ) { | |
| IsCuQpDeltaCoded = 0 | |
| CuQpDeltaVal = 0 | |
| CuQgTopLeftX = x0 | |
| CuQgTopLeftY = y0 | |
| } | |
| if( sh_cu_chroma_qp_offset_enabled_flag && qgOnC && | |
| cbSubdiv <= CuChromaQpOffsetSubdiv ) { | |
| IsCuChromaQpOffsetCoded = 0 | |
| CuQpOffset_{Cb} = 0 | |
| CuQpOffset_{Cr} = 0 | |
| CuQpOffset_{CbCr} = 0 | |
| } | |
| if( split_cu_flag ) { | |
| if( ( allow SplitBtVer \|\| allowSplitBtHor \|\| allowSplitTtVer \|\| allowSplitTtHor ) && | |
| allowSplitQt ) | |
| split_qt_flag | ae(v) |
| if( !split_qt_flag ) { | |
| if( ( allowSplitBtHor \|\| allowSplitTtHor ) && | |
| ( allowSplitBtVer \|\| allowSplitTtVer ) ) | |
| mtt_split_cu_vertical_flag | ae(v) |
| if( ( allowSplitBtVer && allowSplitTtVer && mtt_split_cu_vertical_flag ) \|\| | |
| ( allowSplitBtHor && allowSplitTtHor && !mtt_split_cu_vertical_flag ) ) | |
| mtt_split_cu_binary_flag | ae(v) |
| } | |
| if( ModeTypeCondition = = 1) | |
| modeType = MODE_TYPE_INTRA | |
| else if( ModeTypeCondition = = 2 ) { | |
| non_inter_flag | ae(v) |
| modeType = non_inter_flag ? MODE_TYPE_INTRA : MODE_TYPE_INTER | |
| } else | |
| modeType = modeTypeCurr | |

### VVC Splitting Restrictions

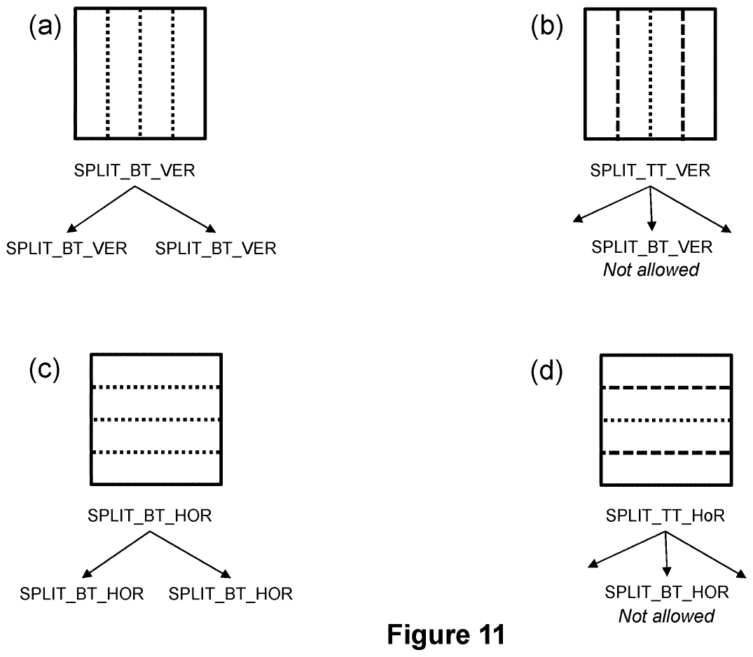

The VVC partitioning has several restrictions. These restrictions are mainly to avoid the same partitioning after several consecutive splits. FIG. 11 illustrates some of these constraints. The idea is to avoid the same partitioning with BT and TT. As depicted in FIG. 11(a) two consecutive vertical BT split are allowed but a vertical TT followed by a vertical BT split in the center block is not allowed as depicted in FIG. 11 (b).

In the same way, As depicted in FIG. 11 (c) two consecutive horizontal BT split are allowed but a horizontal TT followed by a horizontal BT split in the center block is not allowed as depicted in FIG. 11 (d).

In VVC there are additional constraints for the minimum chroma block size and for the TT and BT maximum block size for inter block size. These constraints have been removed for the ECM software.

### Chroma Partitioning

In VVC, the Chroma partitioning may be inferred based on the Luma partitioning but this can be disabled. When the Dual tree mode is enabled, the partitioning tree of Chroma is independent to the tree of Luma. But some restrictions exist.

The tree can be also partially dependent to the Luma partitioning for the CCLM mode, otherwise it is independent.

### Picture Boundary

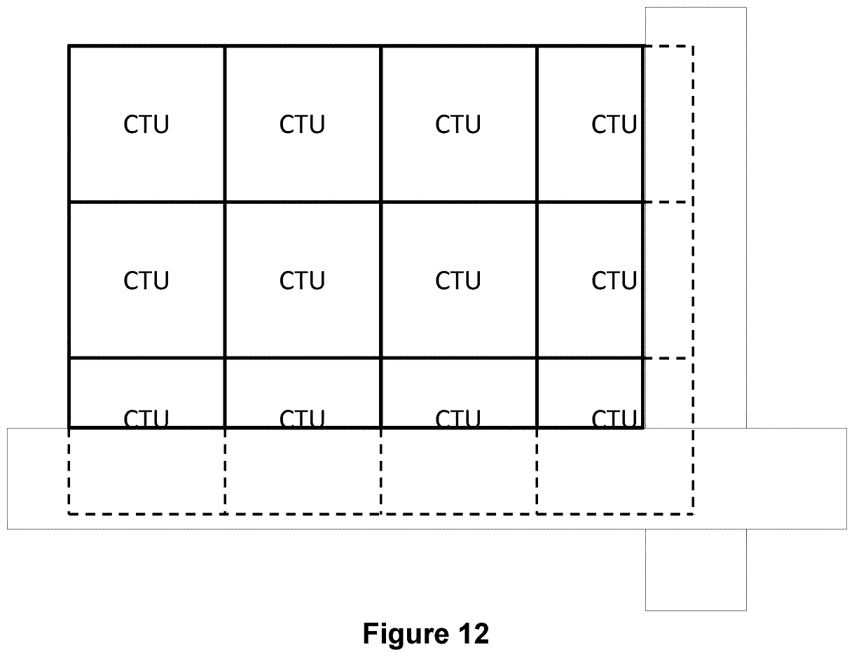

The frame resolution is not always equal to an integer multiple of CTU size. Consequently, there can be incomplete CTUs in the borders of the frame as depicted in FIG. 12 where CTUs 1201-1206 are incomplete due to the bottom and right boundaries 1207, 1208 of the frame. In VVC, in contrast to the previous standards, the signaling of the split is allowed at the picture boundary. The splitting process in the boundary is applied until that the coding tree node represents a CU located entirely within a picture. But some splits are inferred (not transmitted). Consequently, the different variables such as MaxMttDepth, MinQtDepth MinQTsize, are increased or decreased according to the possible splits not in the boundary.

### QT BT TT Encoding Choice

In the VTM and ECM software several encoder side optimizations are used for the QT BT TT encoding choice.

One such optimization includes determining if the QT split is tested before the BT split.

The condition is that at least one CU on the left or above the current coding tree node has a QT depth larger than the QT depth of the current coding tree node; and if the CU width represented by the current coding tree node is greater than MinQTSize*2.

If this condition is true then the QT is before BT and the splits will be treated as the following order:
No Split
QT
BT Horizontal
BT Vertical
TT Horizontal
TT Vertical

Otherwise, the order will be:
No Split
BT Horizontal
BT Vertical
TT Horizontal
TT Vertical
QT

This order is important as according to some optimizations, several splits will not be tested depending on results of the first tested modes. So, when QT is tested last there is a lot of occasions where it will not be evaluated.

### MaxMttDepth

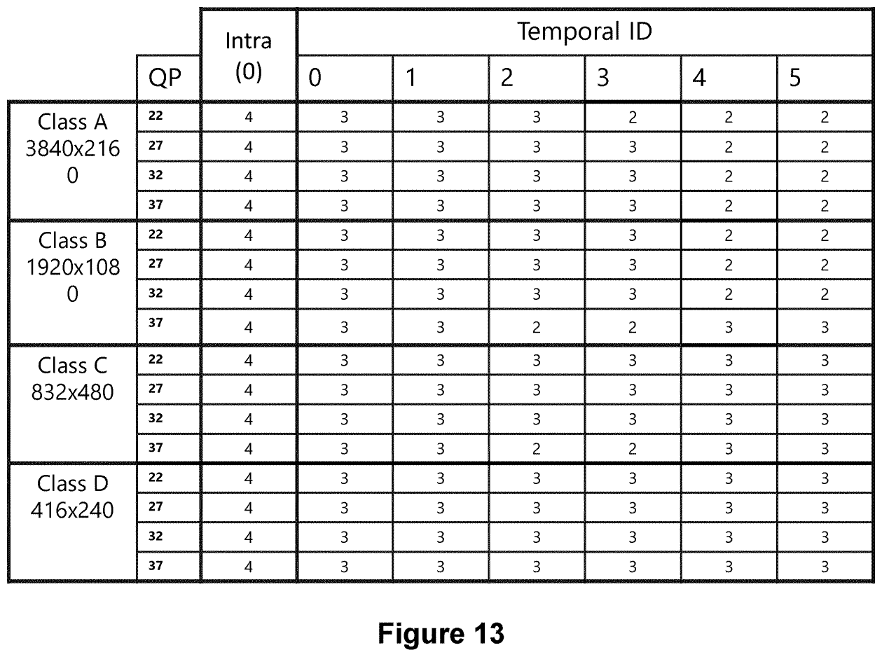

The maximum MTT depth has a significant impact on the encoder complexity. The common test conditions for the ECM have been updated to reduce the encoding by settings different MaxMttDepth as depicted in FIG. 13. In this setting, the MaxMttDepth is lower for some temporal ID for large resolutions or small QP settings.

### Adaptive MaxBTSize

In the VTM and ECM, there is a frame level encoding choice which sets the MaxBTSize according to the average block sizes of the previous encoded frames with the same depth (=>same temporal ID within CTC RA case). The average block size is compared to thresholds as the following pseudo code:

```
  if( dBlkSize < AMAXBT_TH32 )
{
  newMaxBtSize = 32;
}
else if( dBlkSize < AMAXBT_TH64 )
{
  newMaxBtSize = 64;
}
    else if( dBlkSize < AMAXBT_TH128 )
{
  newMaxBtSize = 128;
}
else
{
  newMaxBtSize = 256;
}
```

Where AMAXBT_TH32 is equal to 15, AMAXBT_TH64 is equal to 30 and AMAXBT_TH128 is equal to 60. This method decreases the maximum BT size when the average block size is small and increases it when it is large.

### Embodiments

### One Partitioning Parameter is Set According to at Least Another Parameter.

In embodiments, there is a process of partitioning image or video data in which one first partitioning parameter (for controlling or determining the partitioning of the image data) is set or determined according to at least another second parameter. The image or video data may be partitioned in a similar manner as described above for VVC or ECM wherein each frame or image is divided into coding tree units (CTUs) which is then further divisible by applying one or more of a plurality of allowed splits. For example, the splits may include a no split (no further splitting is carried out), a binary tree split (whereby a block or unit of the coding tree is subdivided into two further blocks or units), a ternary tree split (whereby a block or unit of the coding tree is subdivided into three blocks or units) and a quad tree split (subdivision into 4 equally sized units or blocks). The binary and ternary splits may be performed horizontally or vertically and the resulting blocks following the split may have different sizes. In this context, a partitioning parameter may refer to a variable or syntax element which determine in what circumstances the aforementioned splits can be used e.g. maximum or minimum depths for a particular split type. In this embodiment, the first parameter value will be dependent om some way according to the value of the second parameter. In this embodiment, the second parameter can be any variable or a syntax element and is not limited to other partitioning parameters.

The main advantage of this embodiment is a coding efficiency improvement thanks an adapted setting of the first parameters according to the value of the second parameter. On second advantage can be an encoding time reduction thanks a reduction of the possible partitioning (e.g. split modes).

### One Partitioning Parameter Representing a Max Partitioning Depth is Set According to at Least Another Parameter

In an embodiment, one first partitioning parameter represents a maximum partitioning depth (i.e. for one or more of the available splits). This first parameter is set or determined according to at least another (second) parameter. In this embodiment the first parameter value will be dependent according to the value of the second parameter. In this embodiment, the second parameter can be a variable or a syntax element.

### One Partitioning Parameter for the Current Block is Set According to at Least Another Parameter for the Current Block.

In an embodiment, one first partitioning parameter for a current block is set or determined according to at least another second parameter of this current block.

The advantage is an increase of coding efficiency compared to the first embodiments thanks to the adapted setting of the value of the first parameters block by block (i.e. rather than at CTU or a higher level such as Slice, Picture or Sequence level of the image data encoded in the bitstream).

In an embodiment, one first partitioning parameter represents a maximum partitioning depth for a current block and it is set or determined according to at least another second parameter of this current block. For example, the second parameter represents another partitioning depth. In another example, the second parameter is a block size.

### The Maximum Multi Tree Depth of the Current Block is Determined Based on at Least the QT Depth of Current Block or on the Block Size.

In an embodiment, the maximum multi tree depth of the current block is determined based on the QT depth of current block or on the block size of the current block.

The advantage is an increase of coding efficiency and possibly an encoder run time reduction and an encoder complexity reduction. Indeed, as described in the prior art section, the MaxMttDepth is set to a fixed value transmitted at a high-level header. But the present inventors have found that the efficiency of the MaxMttDepth is closely related to the QT depth value of the current block as well as the impact of the encoding run time. Thanks to a setting of the MaxMttDepth according to the QT depth value, the coding efficiency is kept compared to use a higher MaxMttDetph. Indeed, the overhead of bitrate for the BT and TT signaling is reduced when unneeded.

### Solution 1

### MaxMttDepth Value is Dependent to the QTDepth and a Reference Value

In an embodiment, the maximum multi tree depth value MaxMttDepth is dependent on the QT Depth (QTDepth) of the current block and a reference value. For example, the reference value may corresponds to another QTDepth. For example, the another QTDepth may be associated with another block or may be a predetermined QT Depth reference value. The value MaxMttDepth for the current block is set based on the value of the QT depth of the current block according to the reference value.

### OTDepth and OTDepthTempo

MaxMttDepth Value is Dependent to the QTDepth and a QtdepthTempo from a Temporal Area

In an embodiment, the maximum multi tree depth value MaxMttDepth is dependent to the QTDepth of the current block and a QT depth from a temporal area QTDepthTempo. Compared to the previous embodiment, the reference value is a QT depth from a temporal area. For example, the value of MaxMttDepth for the current block is set based on the value of QT depth of the current block based on QT depth obtained from a temporal block.

The advantage is an optimal coding efficiency improvement as the QT depth from a temporal area is a reference value which reflect optimally the behavior for the current block and its area as it has been selected.

### Increase the MaxMttDepth According to One or More Rules or Conditions

In an embodiment, the current maximum multi tree depth MaxMttDepth (from the header) is increased according to at least one rule or condition based on the QT depth of the current block and the QT depth from the temporal area.

The advantage is a coding efficiency improvement with a minor impact on encoding time increase.

### Increase the MaxMttDepth Value QTDepth==QTDepthTempo

In an embodiment, the current maximum multi tree depth MaxMttDepth (from the header) is increased (e.g. incremented by one) when the condition that the QT depth of the current block and the QT depth from the temporal area are equal is satisfied. The following pseudo code illustrates one possible implementation of this embodiment:

If (QTDepth == QTDepthTempo)
{
MaxMttDepth++
}

The advantage of this example is that it saves about 80% of the gain of an increase of MaxMttDepth (from the header) of 1 for all QT depth with only 10% of the encoder run time increase. So, this particularly efficient.

### Increase the MaxMttDepth Value QTDepth==QTDepthTempo) OR (QTDepth==QTDepthTempo−1)

In one alternative embodiment, the current maximum multi tree depth MaxMttDepth (from the header) is increased when the QT depth of the current block is equal to the QT depth from the temporal area or when the QT depth of the current block is equal to the QT depth from the temporal area minus 1. The following pseudo code illustrates of example of this embodiment:

If ((QTDepth == QTDepthTempo) OR (QTDepth == QTDepthTempo −
1 ))
{
MaxMttDetph++
}

Alternatively, the current maximum multi tree depth MaxMttDepth (from the header) is only increased when the QT depth of the current block is equal to the QT depth from the temporal area minus 1 as the following:

If ( QTDepth == QTDepthTempo − 1 )
{
MaxMttDetph++
}

Compared to the previous embodiment, this one is more complex but it gives larger coding efficiency. More precisely, when QTDepth is equal to QTDeptTempo minus 1, the coding efficiency is larger as the encoder run time. But this depends also to the frame where the temporal area comes from.

### Decrease the MaxMttDepth Value According to Some Rules

In an embodiment, the current maximum multi tree depth MaxMttDepth is decreased according to at least one rule based on the QT depth of the current block and the QT depth from the temporal area.

The advantage is an encoding time decrease with sometimes a positive impact of the coding efficiency as a piece of the rate dedicated to the signaling of the BT and TT partitioning can be saved.

Decrease when NOT((QTDepth==QTDepthTempo) OR (QTDepth==QTDepthTempo−1))

In an embodiment, the current maximum multi tree depth MaxMttDepth (from the header) is decreased when the QT depth of the current block is not equal to the QT depth from the temporal area or when the QT depth of the current block is not equal to the QT depth from the temporal area minus 1. The following pseudo code illustrates of example of this embodiment:

If (NOT(QTDepth == QTDepthTempo) OR (QTDepth ==
QTDepthTempo − 1 ))
{
MaxMttDepth−−
}

The advantage is an encoding time decrease with a small coding efficiency increase.

Decrease when NOT(QTDepth==QTDepthTempo))

In one additional embodiment, the current maximum multi tree depth MaxMttDepth is decreased when the QT depth of the current block is not equal to the QT depth from the temporal area. The following pseudo code illustrates one example of this embodiment:

If (NOT(QTDepth == QTDepthTempo))
{
MaxMttDepth−−
}

The advantage is an increase of the encoding time decrease compared to the previous embodiment but with an impact on coding efficiency.

Decrease when QTDepth>QTDepthTempo

In an embodiment, the current maximum multi tree depth MaxMttDepth is decreased when the QT depth of the current block is greater than the QT depth from the temporal area. The following pseudo code illustrates one example of this embodiment:

If (QTDepth > QTDepthTempo)
{
MaxMttDepth−−;
}

This embodiment offers less complexity than the previous embodiment yet it gives better coding efficiency.

Additionally, this decrease can be applied only when the maximum Multi tree depth of the current frame is equal to the maximum multi tree depth of the temporal area. (PH_MaxMttDepth==MaxMttDepthTempo).

Only when the Temporal Frame is Better than the Current Frame

In an additional embodiment, the previous embodiment is only applied or enabled when the temporal area comes from a temporal frame with a better quality coding than the current frame. A better quality of coding, for example, can be a lower QP for the temporal frame than the current one.

The advantage is an optimal coding efficiency, indeed, if the temporal frame has a better coding, its average blocks size should be lower than the current frame, so it is better to reduce the maximum multi tree depth for the cases when the current QT depth is greater than to the QT depth from the temporal area.

Decrease when QTDepth<QTDepthTempo−1

In an embodiment, the current maximum multi tree depth MaxMttDepth is decreased when the QT depth of the current block is less than the QT depth from the temporal area minus 1. The following pseudo code illustrates one example implementation of this embodiment:

If (QTDepth < QTDepthTempo − 1)
{
MaxMttDepth−−;
}

This embodiment offers also a complexity reduction and the coding efficiency increase as the previous one.

Additionally, this decrease of MaxMttDepth may be applied only when the maximum Multi tree depth of the current frame is equal to the maximum multi tree depth of the temporal area. (PH_MaxMttDepth==MaxMttDepthTempo).

Only when the Current Frame is Better than the Temporal Frame

In an additional embodiment, the previous embodiment is only enabled when the current frame has a better quality of coding than the temporal frame of the temporal area. A better quality of coding, for example, can be a lower QP for the temporal frame than the current frame.

The advantage is an optimal coding efficiency, indeed, if the current frame has better quality coding, its average blocks size should be lower than the temporal frame, so it is better to reduce the maximum multi tree depth for the cases where the current QT depth is less than to the QT depth from the temporal area minus 1 and alternatively, less than or equal to the QT depth from the temporal area only. This can depend on the difference between QP for example.

Decrease Only when QTDepthTempo<PH_QTDepth

In an embodiment, the current maximum multi tree depth MaxMttDepth is decreased when the temporal maximum QT depth of the current block is less than the QT depth of the current frame. The following pseudo code illustrates one example implementation of this embodiment:

If (QTDepthTempo < PH_QTDepth)
{
MaxMttDepth−−;
}

This embodiment can be combined with the other embodiments which implement a conditional decrease of MaxMttDepth. Please note that the QT depth of the current frame (as referred to in the described embodiments) can be computed based on the minimum QT size as this value is not available for example in the VVC specifications. This value is set equal to log 2(CTUSize( )/(minQtSize<<1)).

The advantage is a coding efficiency improvement. Indeed, when the temporal QT depth reaches the current QT depth there is little chance that the maximum multi tree depth should be decreased and, if it less, it is better to decrease the maximum multi tree depth to reduce the encoding time as it can be compensated by a higher QT depth for the current block.

### Combination of Embodiments to Conditionally Increase and Decrease MaxMttDepth

In an embodiment, the different embodiments to increase and to decrease the MaxMttDepth are combined. For example, FIG. 14 illustrates one of this combination. In this figure the PH_MaxMttDepth is the MaxMttDepth for the current picture. In this example, the current maximum multi tree depth MaxMttDepth (from the header) is increased when the QT depth of the current block and the QT depth from the temporal area are equal and it is decreased when the QT depth of the current block is not equal to the QT depth from the temporal area or when the QT depth of the current block is not equal to the QT depth from the temporal area minus 1. The following pseudo code illustrates one example of this embodiment:

```
If (QTDepth == QTDepthTempo)
{
  MaxMttDepth++
}
If (NOT(QTDepth == QTDepthTempo) OR (QTDepth ==
QTDepthTempo − 1 ))
{
  MaxMttDepth−−
}
```

The advantage is a better coding efficiency and an increase of encoding time reduction.

### Based on a Formula

In an embodiment, the value of maximum multi tree depth MaxMttDepth is determined block by block thanks to a formula. For example, this formula contains the QTdepth and additionally the QTDepthTempo. For example, the formula can be:

$$MaxMttDepth = 2 * QTDepthTempo - QTDepth + 1 \\ Or alternatively$$

$$MaxMttDepth = min ( 2 * QTDepthTempo - QTDepth + 1 , MaxMttDepth ) \\ Or alternatively$$

$$MaxMttDepth = min ( QTDepth - ( QTDepthTempo - 2 ) + 1 , MaxMttDepth + 1 )$$

### The Reference Value is HLS (High Level Syntax) Coded

### The Reference Value is Transmitted in a Header

In an embodiment, the maximum multi tree depth value MaxMttDepth is dependent to the QTDepth of the current block and a reference value. And the reference value is transmitted in a header. For example, this value can be additionally or alternatively transmitted in the SPS, PPS, Picture header, slice header.

Compared to the embodiments based on the QT Depth temporal, this embodiment does not need to access to the frame which contains the temporal QT depth. This simplifies the process.

### All Previous Embodiments can be Applied

All previous embodiments which used the QT depth determined based on the temporal area can be applied. For example, similarly to FIG. 14 the QT depth of the current block is compared to the picture header QT Depth “PH_QTDeph” to derive the current MaxMttDepth. In this example, the current maximum multi tree depth MaxMttDepth is increased when the QT depth of the current block and the PH_QTDeph are equal and it is decreased when the QT depth of the current block is not equal to the PH_QTDeph or when the QT depth of the current block is not equal to the PH_QTDeph minus 1. The following pseudo code illustrates one example of this embodiment:

```
If (QTDepth == PH_QTDeph)
{
  MaxMttDepth++
}
If (NOT(QTDepth == PH_QTDeph) OR (QTDepth == PH_QTDeph − 1
))
{
  MaxMttDepth−−
}
```

Taking into Account MaxMTTDepthTempo
The MaxMTTDepthTempo is Taken into Account to Determine Current MaxMTTDepthTempo

In an embodiment, the maximum Multi tree depth from a temporal area “MaxMTTDepthTempo” is taken into account to determine the value of MaxMttDepth for the current block.

Increase MaxMttDepth when PH_MaxMttDepth<MaxMttDepthTempo

In an embodiment, the value of the MaxMttDepth is increased when the high level maximum multi tree depth “PH_MaxMttDepth” is less than MaxMttDepthTempo. The following pseudo code illustrates on example of this embodiment:

If (PH_MaxMttDepth < MaxMttDepthTempo)
{
MaxMttDepth++
}

The advantage is a coding efficiency improvement as if Maximum multi tree depth of the temporal area is greater than the MaxMttDepth or PH_MaxMttDepth, there is a lot of chances that the value of MaxMttDepth should be increased to reach the maximum usefulness of this parameter in term of coding efficiency.

### PH_MaxMttDepth<MaxMttDepthTempo

In an embodiment, the value of the MaxMttDepth is increased by combined a criterion based on the high level maximum multi tree depth “PH_MaxMttDepth” and the maximum multi tree depth temporal “MaxMttDepthTempo” and a criterion based on the current QT depth and the QT depth from a temporal area.

For example, the value of the MaxMttDepth is increased when the high level maximum multi tree depth “PH_MaxMttDepth” is less than MaxMttDepthTempo and when the QT depth of the current block and the QT depth from the temporal area are equal. The following pseudo code illustrates one example of this embodiment:

```
If (PH_MaxMttDepth < MaxMttDepthTempo)
{
  If (QTDepth == QTDepthTempo)
  {
    MaxMttDepth++
  }
}
```

The advantage is a coding efficiency improvement with a minimal impact on the encoding run time compared to the embodiment without the combination.

Limit the Increase Based on Average MTT Temporal (mttDepthTempo)

In an embodiment, the increase of MaxMttDepth is limited based on the average MTT temporal (mttDepthTempo).

The advantage is a coding efficiency improvement and a complexity reduction. Indeed, if the maximum MTT depth MaxMttDepth is increased when it is not needed, this increases the rate dedicated to the partitioning. The encoding time reduction, compared to the previous embodiment, is given, by less possible MTT splits which are evaluated.

### Limitation Compared to the PH_MaxMttDepth

In an embodiment, the average of temporal MTT values, mttDepthTempo, is compared to the maximum MTT depth value, PH_MaxMttDepth, to determine if the current maximum MTT depth MaxMttDepth needs to be increased. In an additional embodiment, the MaxMttDepth is increased if the average of temporal MTT values, is greater than or equal to the half of picture header maximum MTT depth, PH_MaxMttDepth. The picture header maximum MTT depth, PH_MaxMttDepth is halved by dividing by 2 or bit shifting to the right by 1. The following pseudo code illustrates one example implementation of this embodiment:

```
If (PH_MaxMttDepth < MaxMttDepthTempo)
{
  If (QTDepth == QTDepthTempo)
  {
    If (mttDepthTempo >= (PH_MaxMTTDepth >> 1))
    {
      MaxMttDepth++
    }
  }
}
```

Alternative embodiments can be considered for the pseudocode. For example, the pseudocode can use a greater than inequality as follows:

$$If ( mttDepthTempo > ( PH\_MaxMTTDepth >> 1 ) )$$

An offset may also be added for the right shift as follows:

$$If ( mttDepthTempo >= ( ( PH\_MaxMTTDepth + 1 ) >> 1 ) )$$

The advantage is the same as the previous embodiment (i.e., a coding efficiency improvement and a complexity reduction).

### Limitation Compared to the PH_MaxMttDepthTempo

In an embodiment, the average of temporal MTT values, mttDepttTempo, is compared to the maximum MTT depth value of the reference frame, PH_MaxMttDepthTempo, to determine if the current maximum MTT depth MaxMttDepth needs to be increased. In an additional embodiment, the MaxMttDepth is increased if the average of temporal MTT values, is greater than or equal to the half of picture header maximum MTT depth of the reference frame, PH_MaxMttDepthTempo. The picture header maximum MTT depth, PH_MaxMttDepth, is halved by dividing by 2 or bit shifting to the right by 1. The following pseudo code illustrates one example implementation of this embodiment:

```
If (PH_MaxMttDepth < MaxMttDepthTempo)
{
  If (QTDepth == QTDepthTempo)
  {
    If (mttDepthTempo >= (PH_MaxMTTDepthTempo >> 1))
    {
      MaxMttDepth++
    }
  }
}
```

Alternative embodiments can be considered for the pseudocode. For example, the pseudocode can use a greater than inequality as follows:

$$If ( mttDepthTempo > ( PH\_MaxMTTDepthTempo >> 1 ) )$$

An offset may also be added for the right shift as follows:

$$If ( mttDepthTempo >= ( ( PH\_MaxMTTDepthTempo + 1 ) >> 1 ) )$$

The advantage is the same as the previous embodiment i.e., a coding efficiency improvement and a complexity reduction.

Not Increased when mttDepthTempo==PH_MaxMttDepth or PH_MaxMttDepthTempo

In an embodiment, the maximum MTT depth value, MaxMttDepth, is not increased when the average of temporal MTT value, mttDepthTempo, is equal to the picture header maximum MTT depth of the reference frame, PH_MaxMttDepthTempo, or alternatively, when it is equal to the temporal maximum MTT depth, MaxMttDepthTempo. Indeed, when mttDepthTempo reaches this value, it is sure that it is useful to increase the maximum MTT depth for the current block but this also increases the encoder run time.

In the same way, the maximum MTT depth value, MaxMttDepth, is not increased when the average of temporal MTT value, mttDepthTempo, is equal to the picture header maximum MTT depth, PH_MaxMttDepth.

The advantage is a further encoding run time reduction with a slight coding efficiency decrease relative to the previous embodiments. This offers a good trade-off between gain and complexity.

### Limitation Only for (QTDepth==QTDepthTempo)

In an embodiment, the previous embodiments are applied only when the current QT depth, QTDepth is equal to temporal QT depth.

The advantage is a coding efficiency improvement compared to the relative previous embodiments

### Specific Limitation for (QTDepth==QTDepthTempo−1)

In an embodiment, the previous embodiments are applied when the current QT depth, QTDepth is equal to temporal QT depth minus 1. However, the maximum MTT depth does not increase in the same way as for the case when QTDepth is equal QTDepthTempo.Instead, when the current QT depth, QTDepth is equal to temporal QT depth minus 1, the maximum MTT depth, MaxMttDepth, is increased only when, the average of MTT depth temporal values, mttDepthTempo is equal to the PH_MaxMTTDepthTempo or alternatively equal to PH_MaxMTTDepth of the current frame or to the MaxMttDepthTempo.

The following pseudo code illustrates one example implementation of this:

```
If (PH_MaxMttDepthTempo < MaxMttDepthTempo)
{
  If (QTDepth == QTDepthTempo−1)
  {
    If (mttDepthTempo == (PH_MaxMTTDepthTempo >> 1))
    {
      MaxMttDepth++
    }
  }
}
```

Alternatively, the average MTT depth temporal, mttDepthTempo, may be less than or equal to the PH_MaxMTTDepthTempo. In another example, the average MTT depth temporal, mttDepthTempo, may be less than or equal to PH_MaxMTTDepth of the current frame or to the MaxMttDepthTempo. The following pseudo code illustrates one example implementation of this:

```
If (PH_MaxMttDepthTempo < MaxMttDepthTempo)
{
  If (QTDepth == QTDepthTempo−1)
  {
    If (mttDepthTempo <= (PH_MaxMTTDepthTempo >> 1))
    {
      MaxMttDepth++
    }
  }
}
```

Alternative embodiments can be considered for the pseudo code. For example, the pseudocode can use a less than inequality as the following:

$$If ( mttDepthTempo < ( PH\_MaxMTTDepthTempo >> 1 ) )$$

An offset may also be added for the right shift as follows:

$$If ( mttDepthTempo <= ( ( PH\_MaxMTTDepthTempo + 1 ) >> 1 ) )$$

The advantage is a coding efficiency improvement relative to the previous embodiments. Indeed, when the current QT depth is equal to the temporal QT Depth minus 1, it is more efficient to increase the maximum MTT, MaxMttDepth, for the current block only for the low value of the average of temporal MTT value, mttDepthTempo.

Decrease MaxMttDepth when PH_MaxMttDepth>MaxMttDepthTempo

In an embodiment, the value of the MaxMttDepth is decreased when the high level maximum multi tree depth “PH_MaxMttDepth” is greater than MaxMttDepthTempo. The following pseudo code illustrates one example of this embodiment:

If (PH_MaxMttDepth > MaxMttDepthTempo)
{
MaxMttDepth−−
}

The advantage is an encoder run time decrease with a coding efficiency improvement. As if MaxMttDepthTempo is less than the MaxMttDepth or PH_MaxMttDepth, there is a lot of chances that the value of MaxMttDepth should be decreased to reach the maximum usefulness of this parameter in term of coding efficiency.

Decrease MaxMttDepth when PH_MaxMttDepth>MaxMttDepthTempo and when the QP of the Current Slice/Frame is Superior or Equal to the QP of Frame of the Temporal Area

In an embodiment, the value of the MaxMttDepth is decreased when the high level maximum multi tree depth “PH_MaxMttDepth” is greater than MaxMttDepthTempo and when the when the QP of the current slice/frame “currentQP” is superior or equal to the QP of slice/frame of the temporal area “tempoQP”. The following pseudo code illustrates one example of this embodiment:

```
If (PH_MaxMttDepth > MaxMttDepthTempo)
{
  If(currentQP >= tempoQP)
  {
    MaxMttDepth—
  }
}
```

Compared to the previous, the advantage of this embodiment is a coding efficiency improvement. Indeed, when the current QP is superior or equal to the QP of slice/frame of the temporal area, the maximum multi tree depth of the current block is generally higher.

Decrease According to Previous Rules Only when the PH_MaxMttDepth==MaxMttDepthTempo

In an embodiment, the maximum multi tree depth a requirement for the maximum multi tree depth to be decreased is that the maximum multi tree depth of the current frame is equal to the maximum multi tree depth of the temporal area. (PH_MaxMttDepth==MaxMttDepthTempo).

For example, the decrease may be applied for all QT depths different to the temporal QT depth and the temporal QT depth minus 1 as described in some previous embodiments. The following pseudocode illustrates this embodiment

```
if (PH_MaxMttDepth == MaxMttDepthTempo)
{
  if (NOT((QTDepth == QTDepthTempo) OR (QTDepth ==
  QTDepthTempo − 1 )))
  {
    MaxMttDepth−−
  }
}
```

This gives a coding efficiency improvement. Indeed, when the maximum multi tree depth is equal to the temporal maximum multi tree depth of the temporal area, there is a high probability that the selected QT depth for the current block will be equal to the temporal QT depth or temporal QT depth minus 1, so for the other QT depth values, the maximum multi tree depth can be decreased.

Additionally, this criterion can be applied only when the temporal frame has a better coding quality than the current one (eq. a lower QP).

Decrease Only when the PH_MaxMttDepth is Equal to PH_MaxMttDepthTempo

In an embodiment, for the maximum multi tree depth to be decreased an it is in additional requirement that the maximum multi tree depth of the current frame is equal to the maximum multi tree depth of a temporal frame. (PH_MaxMttDepth==PH_MaxMttDepthTempo).

For example, when applied to the example of the previous embodiment, the following formula illustrates this embodiment:

```
if ((PH_MaxMttDepth == PH_MaxMttDepthTempo) &&
(PH_MaxMttDepth == MaxMttDepthTempo))
{
  if (NOT((QTDepth == QTDepthTempo) OR (QTDepth ==
  QTDepthTempo − 1 )))
  {
    MaxMttDepth−−
  }
}
```

This gives a coding efficiency improvement especially when it is combined with the previous embodiment.

### Further Decrease of MaxMttDepth

In an embodiment, additionally to the previous embodiments, two decreases of MaxMttDepth are applied if MaxMttDepth has not reached the MaxMttDepthTempo. The following pseudocode illustrates one example implementation of this embodiment:

```
If (PH_MaxMttDepth > MaxMttDepthTempo)
{
  MaxMttDepth = MaxMttDepthTempo
    If (MaxMttDepth > MaxMttDepthTempo)
    {
      MaxMttDepth—
    }
}
```

This pseudocode may be adapted according to the different embodiments as described above.

The advantage of this embodiment is a coding efficiency increase and a further encoding time complexity reduction.

### MaxMttDepth is Equal to MaxMttDepthTempo

In an embodiment additionally to the previous embodiments, the MaxMttDepth is set equal to MaxMttDepthTempo when PH_MaxMttDepth>MaxMttDepthTempo. The following pseudo code illustrates one example implementation of this:

If (PH_MaxMttDepth > MaxMttDepthTempo)
{
MaxMttDepth = MaxMttDepthTempo
}

The advantage of this embodiment is a further encoding time complexity reduction compared to the previous embodiment.

### Decrease Limited to Some Rules

In certain embodiments, the decrease of maximum multi tree depth can be restricted based on one or more parameters. For example, these may be parameters which are indicative of image quality or content relating to Class A video. Embodiments relating to particular parameters are set out below.

$$If ( Resolution > 1920 * 1080 )$$

In an embodiment, the decrease of maximum multi tree depth is applied only for the sequence with a resolution higher than a predetermined resolution. In an embodiment, the predetermined resolution is HD (1920*1080). This is especially efficient when the maximum multi tree depth of the current frame is equal to the maximum multi tree depth of the temporal area. (PH_MaxMttDepth==MaxMttDepthTempo).

### If(CTUSize>=256)

In an embodiment, the decrease of maximum multi tree depth is applied only when the CTU size is for the current frame is greater than or equal to a predetermined value. In an embodiment the predetermined value is 256. This is especially efficient when the maximum multi tree depth of the current frame is equal to the maximum multi tree depth of the temporal area. (PH_MaxMttDepth==MaxMttDepthTempo).

### If (PH_MaxMttDepth<PH_MaxQTDepth)

In an embodiment, the decrease of maximum multi tree depth is applied only when the frame level maximum multi tree depth (PH_MaxMttDepth) of the current frame is less than the maximum possible QT depth for the current frame. This is especially efficient when the maximum multi tree depth of the current frame is equal to the maximum multi tree depth of the temporal area. (PH_MaxMttDepth==MaxMttDepthTempo).

### If (PH_MaxQTDepth>3)

In one embodiment, the decrease of maximum multi tree depth is applied only when the frame level maximum QT depth of the current frame is greater than a predetermined value. In an embodiment the predetermined value is 3. This is especially efficient when the maximum multi tree depth of the current frame is equal to the maximum multi tree depth of the temporal area. (PH_MaxMttDepth==MaxMttDepthTempo).

### MaxMttDepth Decreased Based on a Combined Criterion

In an embodiment, the value of the MaxMttDepth is decreased by combined a criterion based on the high level maximum multi tree depth “PH_MaxMttDepth” and the maximum multi tree depth temporal “MaxMttDepthTempo” and a criterion based on the current QT depth and the QT depth from a temporal area.

For example, the value of the MaxMttDepth is decreased when the high level maximum multi tree depth “PH_MaxMttDepth” is greater than MaxMttDepthTempo and when the QT depth of the current block is not equal to the QT depth from the temporal area or QT depth from the temporal area minus 1. The following pseudo code illustrates one example of this embodiment:

```
If (PH_MaxMttDepth > MaxMttDepthTempo)
{
  If (NOT(QTDepth == QTDepthTempo) OR (QTDepth ==
  QTDepthTempo − 1 ))
  {
    MaxMttDepth−−
  }
}
```

The advantage is an encoder run time decrease with a coding efficiency improvement. compared to the embodiment without the combination.

Increase MaxMttDepth when PH_MaxMttDepth==MaxMttDepthTempo

In an embodiment, the value of the MaxMttDepth is increased when the high level maximum multi tree depth “PH_MaxMttDepth” is equal to MaxMttDepthTempo.

This embodiment offers an important coding efficiency improvement.

### For QTDepth==QTDepthCol Only

In an embodiment, the value of the MaxMttDepth is increased when the high level maximum multi tree depth “PH_MaxMttDepth” is equal to MaxMttDepthTempo and when the current QT depth is equal to the temporal QT depth.

This embodiment gives also important coding gain with smaller impact on encoding run time compared to the previous embodiment.

### For (QTDepth==QTDepthCol) OR (QTDepth==QTDepthTempo−1)

In one alternative embodiment, the value of the MaxMttDepth is increased when the high level maximum multi tree depth “PH_MaxMttDepth” is equal to MaxMttDepthTempo and when the current QT depth is equal to the temporal QT depth or when it is equal to the temporal QT depth minus 1.

For QTDepth==QTDepthCol and QTDepthCol==minQTDepthCol

In an embodiment, for the value of the MaxMttDepth to be increased, the current QT depth must be equal to the temporal QT depth (QTDepth==QTDepthCol) and the temporal QT depth must be equal to the minimum temporal QT depth (QTDepthCol==minQTDepthCol).

This increases the coding efficiency as the temporal QT depth split seems the same for all blocks of the temporal area, so the only way to obtain further splits for the current block is to increase the maximum multi tree depth.

Additionally, this can be applied only in a case where the maximum multi tree depth for the current frame is equal to the temporal maximum multi tree depth (PH_MaxMttDepth==MaxMttDepthTempo) to be sure that the maximum possible split is reached in the temporal area.

### For QTDepth==QTDepthtempo and QTDepthTempo==PH_MaxQTDepth

In an embodiment, the value of the MaxMttDepth is increased when the current QT depth is equal to the temporal QT depth (QTDepth==QTDepthTempo) and when this temporal QT depth is equal to the QT depth of the current frame (QTDepthTempo==PH_MaxQTDepth).

This increases the coding efficiency because the QT depth will typically reach its maximum value for the current block, so, one way to obtain further splits for the current block is to increase the maximum multi tree depth.

Additionally, this can be applied only when the maximum multi tree depth for the current frame is equal to the temporal maximum multi tree depth (PH_MaxMttDepth==MaxMttDepthTempo) to be sure that the maximum possible split is reached in the temporal area.

### Based on a Formula

In an embodiment, the value of the MaxMttDepth is determined based on a formula which depends on the “PH_MaxMttDepth” and on the MaxMttDepthTempo.

### With QTDepth

In an embodiment, the value of the MaxMttDepth is determined based on a formula which depends on PH_MaxMttDepth and/or on the MaxMttDepthTempo and on QT Depth of the current block and/or on the QT depth of the temporal area.

For example, the formula can be:

$$MaxMttDepth = MaxMttDepth - 2 * ( QTDepth - MaxMttDepthTempo ) ;$$

Or alternatively:

$$If ( MaxMttDepth >= MaxMttDepth - 2 * ( QTDepth - MaxMttDepthTempo ) ) \\ MaxMttDepth = MaxMttDepth - 2 * ( QTDepth - MaxMttDepthTempo ) ; \\ Else$$

$$MaxMttDepth = 0$$

### PH_MaxMTTDepth of Temporal Frames

### Same Embodiments as MaxMttDTempo

In an embodiment, the value of the MaxMttDepth is determined based on the high level maximum multi tree depth of a temporal frame “PH_MaxMttDepthTempo”. For example, the frame can be a reference frame or a frame with the same temporal ID. All embodiments defined above for the maximum multi tree depth from a temporal area “MaxMttDTempo” can be applied with the PH_MaxMttDepthTempo instead.

The advantage compared to use the MaxMttDepthTempo instead of MaxMttDTempo is that it does not need to derived the MaxMttDTempo from the temporal area.

This embodiment can be also combined to all others previously described embodiments for a better compromise between coding efficiency encoding run time.

Apply Criterion Only when PH_MaxMttDeptTempo is Greater than PH_MaxMttDept.

In one particular embodiment, the high level maximum multi tree depth of a temporal frame “PH_MaxMttDepthTempo” is compared to the high level maximum multi tree depth of the current frame “PH_MaxMttDept” to know if at least one criterion described above is applied or not. For example, if the PH_MaxMttDeptTempo is greater than PH_MaxMttDept the increase of the MaxMttDepth is allowed, thanks, for example, to one criterion listed above.

For example, when the PH_MaxMttDepth is less than PH_MaxMttDeptTempo and when the PH_MaxMttDepth is also less than MaxMttDepthTempo and when the QTDepth is equal to QTDepthTempo, the MaxMttDepth is increased. The following pseudo code illustrates this example of this embodiment:

```
If (PH_MaxMttDepth < PH_MaxMttDeptTempo)
{
  If (PH_MaxMttDepth < MaxMttDepthTempo)
  {
    If (QTDepth == QTDepthTempo)
    {
      MaxMttDepth++
    }
  }
}
```

The advantage is a good compromise between the encoding run time and the coding efficiency. Indeed, the proposed criterion gives higher gain when the current high level maximum multi tree depth is less than less than the high level maximum multi tree depth of temporal frame (especially with one reference frame).

### Current High Level Maximum Multi Tree<=High Level Maximum Multi Tree Depth

Alternatively, the formula can consider, that the current high level maximum multi tree depth is less than or equal instead of only less than to the high level maximum multi tree depth for higher gain.

### Only for the CTU 256

In one additional embodiment, the restriction based on when the PH_MaxMttDeptTempo is greater than PH_MaxMttDept, is applied only when the CTU size is large. For example, when the CTU size is 256.

### No Decrease if PH_MaxMTTDeptTempo is Inf to PH_MaxMTTDept.

In an embodiment, if PH_MaxMTTDeptTempo is less than PH_MaxMTTDept, the decrease of the MaxMttDepth is not allowed.

The following pseudo code illustrates one example of this embodiment:

```
If (PH_MaxMttDepth <= PH_MaxMttDeptTempo)
{
  If (PH_MaxMttDepth > MaxMttDepthTempo)
  {
    MaxMttDepth−−
  }
}
```

### Specific Decrease for MAXMttDepth

### When the MaxMttDetph is Decreased, it can be Set Equal to 0.

In an embodiment, when the MaxMttDetph is decreased, its value is set equal to 0 instead it being decremented or merely decreased.

The main advantage is a reduction of the rate associated with the BT or TT signaling. The second is a further complexity reduction.

In particular, this embodiment, is applied when there is a lot of chances that the BT and TT splits are not needed. For example, this can be applied when the maximum multi tree depth from the temporal area, MaxMttDepthTempo, is particularly low. It can be also applied when the current QTDepth is set equal to the minimum value of QTDepth, (eq. the CTU size). And it can be also applied when the QTDepth is equal to its maximum possible value (eq. the minimum QT size).

In another example, this embodiment is applied when the current QT depth is superior to the temporal QT Depth (QTDepth>QTDepthTempo).

In another example, this embodiment is applied when the current QT depth is inferior to the temporal QT Depth minus 1 (QTDepth<QTDepthTempo−1).

### Specific Case of Intra Reference Frames

The Intra frames and Inter frames have different partitioning. The partitioning of intra frame follows spatial correlations compared to the partitioning of inter frame which follows temporal correlations. Yet, there is some correlation which can be used to predict some parameters and especially the maximum MTT depth for the current block, MaxMttDepth, as described herein.

No increase of MaxMttDepth for QTDepthTempo−1

In an embodiment, when the reference frame is an intra frame, the increase of MaxMttDepth is applied only when the current QT depth, QTDepth, is equal to QTDepthTempo and not when QTDepth, is equal to QTDepthTempo−1.

The advantage is a complexity reduction with a small impact on coding efficiency.

When there is Another Inter Frame with Different PH_MaxMttDepth

In an embodiment, when the reference frame is an intra frame, the increase of MaxMttDepth is applied only when the current QT depth, QTDepth, is equal to QTDepthTempo and, if all Inter frames in the sequence or the GOP have the same maximum MTT depth (PH_MaxMttDepth). The maximum MTT depth for the current block may also be increased when QTDepth, is equal to QTDepthTempo−1.

The advantage is a coding efficiency improvement with a small encoding time increase. Indeed, the gain is larger when QTDepth is equal to QTDepthTempo−1 for frames with intra frame as reference when all Inter frames have the same PH_MaxMttDepth.

Of course, in these embodiments, the increase of maximum of MTT depth for the current block is conditional on the other conditions as defined previously.

Not Applied when Intra Ref

In an embodiment, when the reference frame is an intra frame, the maximum MTT depth for a current block is not increased according to some conditions.

The advantage is a coding efficiency improvement and an encoding run time reduction or better coding efficiency complexity compromise.

### Not Applied in Same Temporal ID

In an embodiment, when the reference frame is an intra frame, and when this reference frame does not have the same temporal ID (or alternatively the same hierarchy depth), the maximum MTT depth for a current block is not increased. In an example, the maximum MTT depth for a current block is increased, when the reference frame is an intra frame with the same temporal ID.

The advantage is a better coding efficiency complexity compromise.

Not when Intra Ref is Too Close

In an embodiment, when the reference frame is an intra frame, and when the absolute POC difference between the current frame and the reference frame is less than a threshold, the maximum MTT depth for a current block, MaxMttDepth, is not increased. In one example, this threshold is equal to 2 or 3.

The advantage is better coding efficiency complexity compromise.

### Decrease for QTDepthTempo−1

In an embodiment, when the reference frame is an intra frame and when the current QT depth, QTDepth, is equal to the temporal QT Depth minus 1, QTDepthTempo−1, the maximum MTT depth for a current block, MaxMttDepth, is decreased.

The advantage is coding efficiency improvement as well as an encoding time reduction.

Decrease when PH_MaxMttDepth<MaxMttDepthTempo

In an embodiment, when the reference frame is an intra frame and when the current QT depth, QTDepth, is equal to the temporal QT Depth minus 1, QTDepthTempo−1, and when the maximum MTT depth for the current picture, PH_MaxMttDepth, is less than the temporal maximum MTT depth, MaxMttDepthTempo, the maximum MTT depth for a current block, MaxMttDepth, is decreased.

Alternatively, the MaxMttDepthTempo may be replaced by the maximum MTT depth for the reference picture, PH_MaxMttDepthTempo.

The advantage is coding efficiency improvement as well as an encoding time reduction.

Decrease when mttDepthCol is Greater than or Equal to PH_MaxMttDeptTempo

In an embodiment, when the reference frame is an intra frame and when the current QT depth, QTDepth, is equal to the temporal QT depth minus 1, QTDepthTempo−1, and when the average of temporal MTT depth values, mttDepthCol is greater than or equal to the maximum MTT depth of the reference frame, PH_MaxMttDeptTempo, the maximum MTT depth for a current block, MaxMttDepth, is decreased. Alternatively, the equality may be considered instead of the greater than or equal to inequality i.e., the average of temporal MTT depth values, mttDepthCol is equal to the maximum MTT depth of the reference frame, PH_MaxMttDeptTempo.

Alternatively, the PH_MaxMttDeptTempo may be replaced by the temporal maximum of MTT depth values, MaxMttDepthTempo.

The advantage is coding efficiency improvement as well as an encoding time reduction.

Decrease MaxMttDepth when PH_MaxMttDepth<MaxMttDepthTempo and when mttDepthCol is Greater than or Equal to PH_MaxMttDeptTempo

In an embodiment, both previous embodiments are combined. In this embodiment, when the reference frame is an intra frame and when the current QT depth, QTDepth, is equal to the temporal QT depth minus 1, QTDepthTempo−1, and when the maximum MTT depth for the current picture, PH_MaxMttDepth, is less than the temporal maximum MTT depth, MaxMttDepthTempo, and when the average of temporal MTT depth values, mttDepthCol is greater than or equal to the maximum MTT depth of the reference frame, PH_MaxMttDeptTempo, the maximum MTT depth for a current block, MaxMttDepth, is decreased. The alternatives described above also apply to this embodiment. The following pseudo code gives an example implementation of this embodiment.

```
If(ReferenceFrame_is_Intra?)
{
  If (QtDepth == QTDepthTempo −1)
  {
    If (PH_MaxMttDepth < MaxMttDepthTempo)
    {
      If (mttDepthTempo >= PH_MaxMttDeptTempo)
      {
        MaxMttDepth—
      }
    }
  }
}
```

The advantage is a coding efficiency improvement with an encoding time reduction. Indeed, as the maximum MTT depth detected in the intra frame reaches the maximum, there is a high probability that the current block will not be selected with a QT depth equal to temporal QT depth minus 1.

### Specific Case: Following Frames

Increase MaxMttDepth for QTDepthTempo−1, only, when
   PH_MaxMttDepth==PH_MaxMttDepthTEmpo and
   PH_MaxMttDepth<MaxMttDepthTempo

In an embodiment, when the maximum MTT depth for both the current frame and the reference are the same (PH_MaxMttDepth==PH_MaxMttDepthTEmpo) and when the temporal maximum MTT depth is greater than this value (PH_MaxMttDepth<MaxMttDepthTempo), the maximum MTT depth for the current block, MaxMttDepth, is increased, only when the current QT depth is equal to the average temporal QT depth minus 1 (QTDepthTempo−1).

Indeed, when the maximum MTT depth for both the current frame and the reference frame are the same but the temporal maximum MTT depth is greater than this value, it means that the maximum MTT depth has been increased for at least one block in the temporal area and that was useful. But instead of propagating this increase of MTT depth on all following frames, the increase is applied to the QT Depth minus−1.

The advantage is a complexity reduction. Indeed, increasing the maximum MTT depth leads to an increase in the encoding run time. And if for the sequence the setting of frame level maximum MTT depth, is too low, the method will increase the encoding time. So, if, the aim is to keep the encoding it is preferable to propagate this increase at the lower level of QT depth in order to reduce the encoding time.

Specific limitation for (QTDepth==QTDepthTempo−1)

As described before, the same limitation for QTDepth equals QTDepthTempo−1 can be combined to the previous embodiment. So, in an additional embodiment to the previous one, the maximum MTT depth, MaxMttDepth, is increased only when, the average of MTT depth temporal values, mttDepthTempo is equal to the PH_MaxMTTDepthTempo or alternatively equal to PH_MaxMTTDepth of the current frame or to the MaxMttDepthTempo. Alternatively, the average MTT depth temporal, mttDepthTempo, can be less than or equal to the PH_MaxMTTDepthTempo or alternatively equal to PH_MaxMTTDepth of the current frame or to the MaxMttDepthTempo of the temporal area.

Although the embodiments disclosed above have been described in relation to a reference frame which corresponds to an intra frame, the present invention is not limited to this. The embodiments may be adapted such that the reference frame corresponds to an inter frame.

Values from Temporal Area

### From a Temporal Area

In an embodiment, for one or more of the conditions, or rules described previously, the QT depth of the current block is compared to a value determined from a temporal area.

The QT Depth Temporal is the Average QT Depth Value from a Temporal Area

In an embodiment, the QT Depth of the current block is compared to an average of the QT Depth values determined from a temporal area.

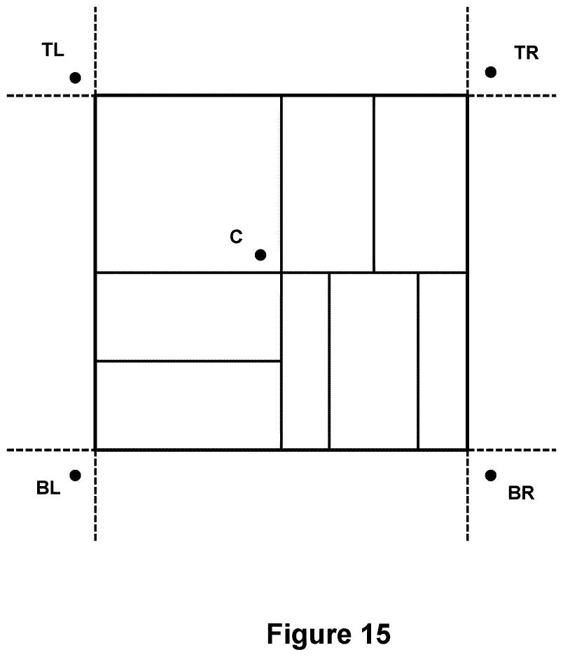

For example, the QT depth values of the temporal positions of FIG. 15 are considered to compute the average value QTDepthTempo which can be used for the criterions

In one alternative a larger temporal area can be considered.

The Other Value is the Minimum QT Depth Value from a Temporal Area

In one alternative embodiment, the QT Depth of the current block is compared to a minimum value of the QT Depth values determined from a temporal area.

MaxMttDepthTempo Value is the Value Computed Thanks to the Maximum MTT Depth or Average MTT Depth from a Temporal Area

In an embodiment, the value compared to the QT depth of the current block for the defined criterions is computed according to the maximum MTT depth from a temporal area “MaxMttDepthTempo”.

Alternatively, the average MTT depth can be considered.

QT Depth is Average of QT Depth from a Temporal Area and MaxMttDepthTempo is a Maximum of MttDepth from a Temporal Area

In one particularly advantageous embodiment, the QT depth from a temporal area is an average of QT depth and the MaxMttDepthTempo is the maximum of MttDepth from the temporal area. For example, by considering that the temporal area contains 10 positions and thanks the following pseudo code described above:

```
If (PH_MaxMttDepth < MaxMttDepthTempo)
{
  If (QTDepth == QTDepthTempo)
  {
    MaxMttDepth++
  }
}
```

The MaxMttDepthTempo is the maximum value of the 10 MttDepth_i from the temporal area with i from 0 to 9. And QTDepthTempo is the average of the 10 QTDepth_i from the temporal area with i from 0 to 9. Additionally, a weighted average is used to consider the block size of each block in the temporal area.

This is particularly efficient. Indeed, the average of QT depths from temporal area gives a correct representation of the QT depth which should be selected for the current block. And thanks, the increase of the maximum multi-tree depth for this case it favorizes its selection. In order to not increase significantly the encoding time and not produce an increase of the rate due to an increase of signaling, the MaxMttDepth for the current block is increased only when the MaxMttDepthTempo is superior to the MaxMttDepth of the current frame. This is in recognition that if the MaxMttDepthTempo is superior there is a lot of chance that the MaxMttDepth for the current block is higher. This gives the best compromise in term of coding efficiency and encoding run time.

The temporal areas used to obtain the average QT depth and the maximum MttDepth may be the same or different. For example, they could be from different reference frames but having the same sizes (and/or positions) or different sizes (and/or positions) or different sizes (and/or positions) and from different reference frames. The different temporal areas may be as set out in the ‘Temporal Area’ embodiments described below.

This embodiment can be combined with any of the embodiments relating to decreasing (or decrementing) MaxMttDepth when PH_MaxMttDepth>MaxMttDepthTempo. For example, one advantageous implementation may be as set out in the following pseudocode.

```
  If (PH_MaxMttDepth < PH_MttDepthTempo)
  {
    If (PH_MaxMttDepth < MaxMttDepthTempo)
    {
      If (QTDepth == QTDepthTempo)
      {
        MaxMttDepth++
      }
    }
  }
If (PH_MaxMttDepth > MaxMttDepthTempo)
{
  If(currentQP >= tempoQP)
  {
    MaxMttDepth—
  }
}
```

Thus, the MaxMttDepth can be optimally adjusted both upwards and downwards to adapt according to the MaxMttDepthTempo, i.e. the maximum multi tree ternary depth from a temporal area (an area of another frame such as a reference frame).

### Temporal Area

### Collocated

In an embodiment, the block considered to determine a temporal value of the QT depth or block size is the QT depth value or the block size of the temporal collocated block or a temporal block shifted by a motion vector value obtain from a neighboring block for example. Similarly, the MaxMttDepth can be the MttDepth of the temporal collocated block or a temporal block shifted by a motion vector value obtain from a neighboring block for example.

A Reference Frame which is an Intra Frame

In an embodiment, the temporal area corresponds to a reference frame which is an intra frame.

### A Plurality of Positions

In an embodiment, several positions of blocks are considered to determine a temporal value of the QT depth or block size or for the MttDepth. For example, the positions C, TL, TR, BL, BR, of FIG. 15 can be considered. In this figure the position C is the center of the temporal collocated block. Positions TL, TR, BL, BR are respectively, the Top Left, Top right, Bottom Left and Bottom Right position around the temporal collocated block.

Compared to the previous embodiment, the current one gives more encoding time reduction and increases the coding efficiency as the temporal QT depth determined or the temporal block size or the temporal MttDepth is more often reliable.

### A Higher Area

In an embodiment, a temporal value of the QT depth or block size or MttDepth is determined based on a temporal area. For example, the temporal area is a collocated CTU.

Compared to the two previous embodiments, more blocks can be considered, so the compromise between the encoding time reduction and the coding efficiency is better.

### The Center of the Current Block is Used to Determine the Temporal Positions

In an embodiment, to determine the collocated block or several temporal blocks or a temporal area, the center of the current block is considered.

The advantage is a better comprise as the center is the best position to represent the current block. Alternatively, when the center of the block is outside the current frame, the top left position is considered.

### A Whole Frame

In an embodiment, a temporal value of the QT depth or the block size or the MttDepth is determined based on all blocks of a temporal frame.

The advantages of this embodiment is a simplification of the process to determine the temporal QT depth or block size or MttDepth value, but it is less efficient because it is less adapted to the content compared to the previous embodiments.

A Frame with the Same Temporal ID

In an embodiment, the collocated block or several temporal blocks or a temporal area, come from a frame with the same temporal ID.

For the example of the Random Access, configuration as represented in FIG. 11, if the current frame has a temporal ID equal to 4, another encoded/decoded frame with the same temporal ID equal to 4 is used to determine the values of the proposed method.

The frames with the same temporal ID often have the same coding parameters, especially they have the same or similar QP and the same spatial distances to their reference frames. So, they are very interesting to predict the QT depth or MttDepth as this data is correlated to the QP and the spatial distance between frames.

The Closest Frame with the Same Temporal ID

In an embodiment, the collocated block or several temporal blocks or a temporal area, come from the closest frame with the same temporal ID.

For the example of the Random Access configuration, as represented in FIG. 11, the closest frame with the same temporal ID is (generally) more correlated than the others. So, the result is better.

A Frame or a Reference Frame with the Same QP

In an embodiment, the collocated block or several temporal blocks or a temporal area, come from a frame or a reference frame with the same QP. Ideally, a reference frame with the same QP.

As mentioned above, the QP has an important influence on the block partitioning. So, with a frame with the same QP, the temporal QT depth or block size or MttDepth is a better predictor.

A Reference Frame which is the Same as Those Used for the Temporal Motion Vector Prediction

In an embodiment, the collocated block or several temporal blocks or a temporal area, come from the reference frame which is used for the temporal motion vector prediction. This can be the first reference of the reference List 0 or the first reference frame of List 1 according to a flag transmitted in the picture header or in the slice header.

Surprisingly, this embodiment gives the best compromise between encoder time reduction and coding efficiency even if this reference frame has a lower QP. Yet, it is closer to the current frame compared to all frames with the same temporal ID.

### The Closest Reference Frame

In an embodiment, the collocated block or several temporal blocks or a temporal area, come from the closest reference frame.

As explained for the previous embodiment, the distance to the current frame seems more interesting for the compromise between encoder time reduction and coding efficiency even if the frames with the same QP have statistically more correlations between their QP depths and Mttdepth.

More than One Reference Frame

In an embodiment, two reference frames are considered and two temporal areas or 2 sets of several blocks or 2 collocated blocks are used to determine 2 temporal QT depths or 2 block sizes. They are then used to determine one QT depth or one block size or one MttDepth. For example, the minimum of QT depth from the 2 temporal areas can be considered.

More than two reference frames can also be considered.

The advantage is a better compromise between encoder time reduction and coding efficiency as the QT depth value or the MttDepth value is computed from more data. This is particularly efficient when both reference frames have the same temporal distance, but it increases the amount of memory accesses.

### Second Solution

In this set of embodiments, the maximum multi tree depth value MaxMttDepth is dependent to the QTDepth of the current block and a reference value which is transmitted in a header instead to be determined. All previous embodiments related to the QTDepthTempo can be applied with the values transmitted.

### Several Values of MaxMttDepth are Transmitted at High Level

In an embodiment, several values of MaxMttDepth are transmitted at high level and are applied according to the QTdepth or the block size. For example, the high-level header can be one or more SPS, PPS, picture header or slice header.

The advantage, compared to the solution based on the temporal area is that the parsing does not depend on the temporal frame. Consequently, the process is simple and the encoder implementations are more flexible. But some data need to be transmitted.

### Associated to Possible QT Depth

In an embodiment, the several values correspond to some QT depths. For example, a table representing these values are transmitted in the picture header.

The size of the table depends on the CTU size and the MinQtSize. For example, the CTU size is equal to 128 and the MinQtSize is equal to 8. So, 4 values are possible, one for the QT depth equals 1 corresponding to the block size 64×64, one for the one for the QT depth equals 2 corresponding to the block size 32×32 and one for the one for the QT depth equals 3 corresponding to the block size 16×16

For example the table is PH_MaxMTTDepth[ ] and the corresponding values are given in the following:

$$PH\_MaxMTTDepth [ 0 ] = 1 \\ PH\_MaxMTTDepth [ 1 ] = 2 \\ PH\_MaxMTTDepth [ 2 ] = 3 \\ PH\_MaxMTTDepth [ 3 ] = 1$$

So, with this embodiment the maxMttDepth for a current block is equal to PH_MaxMTTDepth[QTDepth].

This table replaces the PH_MaxMTTDepth, so these syntax elements can be coded in the same way with ue(v). The syntax elements coded as ue(v) or se(v) are Exp-Golomb-coded with order k equal to 0 in VVC.

### Associated to the Block Size (Log 2)

In an embodiment, the block size to set the maxMttDepth is considered instead of the QT depth. For example, in that case the PH_MaxMTTDepth is replaced by a table PH_MaxMTTDepth_Log 2size_minus2. And for the same configuration as the CTU size equals to 128 and the MinQtSize is equal to 8, the PH_MaxMTTDepth_Log 2size_minus2 is set as the following:

$${PH\_MaxMTTDepth}_{-} Log2size\_minus2 [ 5 ] = 1 // for block 128 x 128 \\ {PH\_MaxMTTDepth}_{-} Log2size\_minus2 [ 4 ] = 2 // for block 16 x 16 \\ {PH\_MaxMTTDepth}_{-} Log2size\_minus2 [ 3 ] = 3 // for block 32 x 32 \\ {PH\_MaxMTTDepth}_{-} Log2size\_minus2 [ 2 ] = 1 // for block 16 x 16$$

The Values of this List are Predicted Between them

In an embodiment, the values are predicted between them to decrease the rate dedicated to the signaling. For example, the PH_MaxMTTDepth[N]=PH_MaxMTTDepthResidual+PH_MaxMTTDepth[N−1];

For example:

$$PH\_MaxMTTDepth [ 0 ] = 1 \\ PH\_MaxMTTDepth [ 1 ] = 1 + PH\_MaxMTTDepth [ 0 ] = 2 \\ PH\_MaxMTTDepth [ 2 ] = 1 + PH\_MaxMTTDepth [ 1 ] = 3 \\ PH\_MaxMTTDepth [ 3 ] = - 2 + PH\_MaxMTTDepth [ 2 ] = 1$$

In this example the values transmitted, for MaxMTTDepthResidual, are 1, 1, 1, −2.

Predicted from Another Header

In an embodiment, the values are predicted thanks a similar value transmitted in another header. So only an update value needs to be transmitted. For example, PH_MaxMTTDepth[N]=PH_MaxMTTDepthResidual[N]+SPS_MaxMTTDepth[N]

Additionally, an overhead flag can signal if the values are updated or not.

Predicted from a Default Value, Only Offset Transmitted

In an embodiment, the values are predicted thanks a default value transmitted or not. For example the regular maxMttDepth is transmitted and the table PH_MaxMTTDepth[ ] is set equal as the following:

$$PH\_MaxMTTDepth = 2 \\ PH\_MaxMTTDepth [ 0 ] = - 1 + PH\_MaxMTTDepth = 1 \\ PH\_MaxMTTDepth [ 1 ] = 0 + PH\_MaxMTTDepth = 2 \\ PH\_MaxMTTDepth [ 2 ] = 1 + PH\_MaxMTTDepth = 3 \\ PH\_MaxMTTDepth [ 3 ] = - 1 + PH\_MaxMTTDepth = 1$$

### Disabled for Screen Content Coding

In an embodiment, the proposed method is adapted to screen content coding. In particular, the method is disabled for screen content. We have discovered that when the content of the sequence contains screen content it seems more difficult to predict the partitioning parameters.

Alternatively, the number of IBC blocks (Intra block coding block—blocks decoded or encoded by reference to an area of samples in the same frame as the block being decoded or encoded) is computed in the temporal area and depending on whether the number of IBC blocks is above or below a threshold, the method is disabled for the current block.

Alternatively, the number of blocks encoded using the palette mode in the temporal area is determined and depending on whether the number of blocks encoded with the palette mode is above or below a threshold, the method is disabled for the current block. For example, if the number of palette mode encoded blocks is higher than a threshold this may be indicative of screen content and thus the method is disabled. The method can be disabled if the palette mode is enabled for the video sequence. Or alternatively, some predetermined criterions can be specifically disabled if the palette mode is enabled for the video sequence. For example, in an embodiment the criterions which determined whether there is to be a decrease in the maximum multi tree depth, MaxMttDepth, may be disabled.

### Disabled for Low Delay Configuration

In an embodiment, the proposed method is adapted to low delay configuration. Especially, the method is disabled for such a configuration.

### When the POC Distance is Too Large (Inter Reference Frame)

In an embodiment, when the reference frame is an inter frame and when the absolute POC difference between the current frame and the reference frame is less than or equal to 2, the maximum MTT depth is increased, otherwise, when the absolute POC difference between the current frame and the reference frame is greater than 2, the maximum MTT depth is not increased. Other restrictions as described in the other embodiments can be also considered.

The advantage is a significant encoding time reduction with a small impact on the coding efficiency. Indeed, when the temporal distance between frames is too large, the temporal correlation decreases. So, the increase of the maximum MTT depth creates additional encoding time complexity for blocks which don't need such an increase.

### When the Reference Frame is an (Inter Reference Frame)

In an embodiment, when the reference frame is an inter frame and when this reference frame has a different temporal ID than the current frame, the maximum MTT depth is increased, otherwise, when the reference frame has the same temporal ID the maximum MTT depth is not increased. Other restrictions as described in the other embodiments can be also considered.

The advantage is a significant encoding time reduction with a small impact on the coding efficiency.

### For High Bit Rate

In an embodiment, when the target bitrate is high or for low QP, the maximum MTT depth is not increased. In a preferred embodiment when the QP for the sequence or the GOP is greater than or equal to 22 the maximum MTT depth is not increased.

The advantage is a significant encoding time reduction with a small impact on the coding efficiency.

### Disabled Using a Flag

In an embodiment, the proposed method is enabled or disabled thanks at least one flag transmitted in at least one a header.

### Disabled/Enabled Increase of MaxMttDepth

In an embodiment, all possible increases of the maximum MTT value for the current block, MaxMttDepth, can be enabled or disabled using a flag transmitted in at least one header. One or more headers can be the SPS, PPS, picture header or the slice header.

The advantage of this embodiment is a flexibility for encoder implementations.

### Disabled/Enabled Increase of MaxMttDepth for QTDepthTempo

In an embodiment, all possible increases of the maximum MTT value for the current block, MaxMttDepth, when the current QT depth (QTDepth) is equal to the temporal average of QT depth (QTDepthTempo), can be enabled or disabled using a flag transmitted in at least one header. One or more headers can be the SPS, PPS, picture header or the slice header.

The advantage of this embodiment is a flexibility for encoder implementations.

### Disabled/Enabled Increase of MaxMttDepth for QTDepthTempo−1

In an embodiment, all possible increases of the maximum MTT value for the current block, MaxMttDepth, when the current QT depth (QTDepth) is equal to the temporal average of QT depth minus 1 (QTDepthTempo−1), can be enabled or disabled using a flag transmitted in at least one header. One or more headers can be the SPS, PPS, picture header or the slice header.

The advantage of this embodiment is a flexibility for encoder implementations.

### Combination of the 3 Previous Embodiments

In an embodiment, the 3 previous embodiments are combined. In this embodiment, a first flag enables or disables the increase of MaxMttDepth. In an example, the first flag enables the increase of MaxMttDepth, a second flag enables or disables the increase when the current QT depth (QTDepth) is equal to the temporal average of QT depth (QTDepthTempo), and a third flag enables or disables the increase when the current QT depth (QTDepth) is equal to the temporal average of QT depth minus 1 (QTDepthTempo−1).

The advantage of this embodiment is an additional flexibility for encoder implementations.

### Disabled/Enabled Decrease of MaxMttDepth

In an embodiment, all possible decreases of the maximum MTT value for the current block, MaxMttDepth, can be enabled or disabled using a flag transmitted in at least one header. One or more headers can be the SPS, PPS, picture header or the slice header.

The advantage of this embodiment is a flexibility for encoder implementations.

### Disabled/Enabled Decrease of MaxMttDepth for QTDepthTempo

In an embodiment, all possible decreases of the maximum MTT value for the current block, MaxMttDepth, when the current QT depth (QTDepth) is equal to the temporal average of QT depth (QTDepthTempo), can be enabled or disabled using a flag transmitted in at least one header. One or more headers can be the SPS, PPS, picture header or the slice header.

The advantage of this embodiment is a flexibility for encoder implementations.

### Disabled/Enabled Decrease of MaxMttDepth for QTDepthTempo−1

In an embodiment, all possible decreases of the maximum MTT value for the current block, MaxMttDepth, when the current QT depth (QTDepth) is equal to the temporal average of QT depth minus 1 (QTDepthTempo−1), can be enabled or disabled using a flag transmitted in at least one header. One or more headers can be the SPS, PPS, picture header or the slice header.

The advantage of this embodiment is a flexibility for encoder implementations.

### Combination of the 3 Previous Embodiments

In an embodiment, the 3 previous embodiments are combined. In this embodiment, a first flag enables or disables the decrease of MaxMttDepth. In an example, the first flag enables the decrease, a second flag enables or disables the decrease when the current QT depth (QTDepth) is equal to the temporal average of QT depth (QTDepthTempo), and a third flag enables or disables the decrease when the current QT depth (QTDepth) is equal to the temporal average of QT depth minus 1 (QTDepthTempo−1).

The advantage of this embodiment is an additional flexibility for encoder implementations.

### The Method can be Applied for Other Split Mode

In one embodiment others partitioning split modes can be applied and the method can be adapted.

### All Embodiments can be Combined

All the described embodiments can be combined unless explicitly stated otherwise. Indeed, many combinations are synergetic and may produce efficiency gains greater than a sum of their parts.

In an embodiment, all previously embodiments related to the QT depth may be alternatively expressed in terms of a block size. Specifically, the QT depth can be expressed as a block size. For example, for CTU equal to 128, QT depth 0 corresponds to block 128×128, QT Depth 1 to block 64×64 etc.

### Further Embodiment(s)

The maximum multi-tree (MTT) depth is temporally predicted for each block. Its value can be increased or decreased or not changed according to the following rules:

The maximum MTT depth can be incremented, for blocks of the current frame, when the reference frame is an Inter frame and it has a different temporal ID and when POC distance to this reference frame is inferior or equal to 2. The maximum MTT depth can also be incremented, when the reference is an Intra frame with the same temporal ID. For the related “current” frames, the maximum MTT depth of each node can be incremented or not according to the following conditions:
the current QT depth is equal to average temporal QT depth minus 1, and the maximum temporal MTT depth is superior to the maximum MTT depth of the current frame, and the temporal average of maximum MTT depth is equal to the half of the picture header maximum MTT depth of the reference frame, and if the reference frame is not an Intra reference frame.
or the current QT depth is equal to the average temporal QT depth, and the temporal maximum MTT depth is superior to the maximum MTT depth of the current frame, and the temporal average of MTT depths is superior or equal to the half of the picture header maximum MTT depth of the reference frame.

The maximum MTT depth can be decremented, for blocks of the current frame, if the palette mode is disabled, or if the current QP is strictly inferior to the QP of the reference frame. For the related frames, the maximum MTT depth of each block can be decremented or not according to the following conditions:
when the maximum QT depth of the current frame is superior to the maximum MTT depth and when the maximum temporal MTT depth is equal to the maximum MTT depth of the current frame, and when the average temporal QT depth is inferior to the QT depth of the current frame.
if the maximum temporal MTT depth is strictly inferior to the maximum multi-tree depth of the current node.

In addition, when the reference frame is Intra and when the current QT depth is equal to average temporal QT depth minus 1 and the maximum temporal MTT depth is superior to the maximum MTT depth, and if the average temporal MTT depth is superior or equal to the picture header maximum MTT depth of the reference frame, the maximum MTT depth is decremented.

### Implementation of the Invention

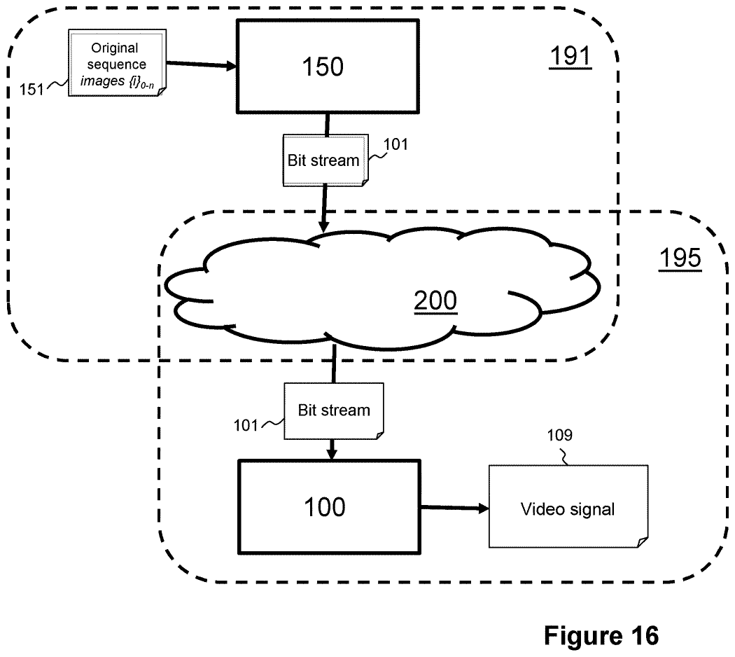

FIG. 16 shows a system 191 195 comprising at least one of an encoder 150 or a decoder 100 and a communication network 199 according to embodiments of the present invention. According to an embodiment, the system 195 is for processing and providing a content (for example, a video and audio content for displaying/outputting or streaming video/audio content) to a user, who has access to the decoder 100, for example through a user interface of a user terminal comprising the decoder 100 or a user terminal that is communicable with the decoder 100. Such a user terminal may be a computer, a mobile phone, a tablet or any other type of a device capable of providing/displaying the (provided/streamed) content to the user. The system 195 obtains/receives a bitstream 101 (in the form of a continuous stream or a signal—e.g. while earlier video/audio are being displayed/output) via the communication network 199. According to an embodiment, the system 191 is for processing a content and storing the processed content, for example a video and audio content processed for displaying/outputting/streaming at a later time. The system 191 obtains/receives a content comprising an original sequence of images 151, which is received and processed (including filtering with a deblocking filter according to the present invention) by the encoder 150, and the encoder 150 generates a bitstream 101 that is to be communicated to the decoder 100 via a communication network 191. The bitstream 101 is then communicated to the decoder 100 in a number of ways, for example it may be generated in advance by the encoder 150 and stored as data in a storage apparatus in the communication network 199 (e.g. on a server or a cloud storage) until a user requests the content (i.e. the bitstream data) from the storage apparatus, at which point the data is communicated/streamed to the decoder 100 from the storage apparatus. The system 191 may also comprise a content providing apparatus for providing/streaming, to the user (e.g. by communicating data for a user interface to be displayed on a user terminal), content information for the content stored in the storage apparatus (e.g. the title of the content and other meta/storage location data for identifying, selecting and requesting the content), and for receiving and processing a user request for a content so that the requested content can be delivered/streamed from the storage apparatus to the user terminal. Alternatively, the encoder 150 generates the bitstream 101 and communicates/streams it directly to the decoder 100 as and when the user requests the content. The decoder 100 then receives the bitstream 101 (or a signal) and performs filtering with a deblocking filter according to the invention to obtain/generate a video signal 109 and/or audio signal, which is then used by a user terminal to provide the requested content to the user.

Any step of the method/process according to the invention or functions described herein may be implemented in hardware, software, firmware, or any combination thereof. If implemented in software, the steps/functions may be stored on or transmitted over, as one or more instructions or code or program, or a computer-readable medium, and executed by one or more hardware-based processing unit such as a programmable computing machine, which may be a PC (“Personal Computer”), a DSP (“Digital Signal Processor”), a circuit, a circuitry, a processor and a memory, a general purpose microprocessor or a central processing unit, a microcontroller, an ASIC (“Application-Specific Integrated Circuit”), a field programmable logic arrays (FPGAs), or other equivalent integrated or discrete logic circuitry. Accordingly, the term “processor” as used herein may refer to any of the foregoing structure or any other structure suitable for implementation of the techniques describe herein.

Embodiments of the present invention can also be realized by wide variety of devices or apparatuses, including a wireless handset, an integrated circuit (IC) or a set of JCs (e.g. a chip set). Various components, modules, or units are described herein to illustrate functional aspects of devices/apparatuses configured to perform those embodiments, but do not necessarily require realization by different hardware units. Rather, various modules/units may be combined in a codec hardware unit or provided by a collection of interoperative hardware units, including one or more processors in conjunction with suitable software/firmware.

Embodiments of the present invention can be realized by a computer of a system or apparatus that reads out and executes computer executable instructions (e.g., one or more programs) recorded on a storage medium to perform the modules/units/functions of one or more of the above-described embodiments and/or that includes one or more processing unit or circuits for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more processing unit or circuits to perform the functions of one or more of the above-described embodiments. The computer may include a network of separate computers or separate processing units to read out and execute the computer executable instructions. The computer executable instructions may be provided to the computer, for example, from a computer-readable medium such as a communication medium via a network or a tangible storage medium. The communication medium may be a signal/bitstream/carrier wave. The tangible storage medium is a “non-transitory computer-readable storage medium” which may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. At least some of the steps/functions may also be implemented in hardware by a machine or a dedicated component, such as an FPGA (“Field-Programmable Gate Array”) or an ASIC (“Application-Specific Integrated Circuit”).

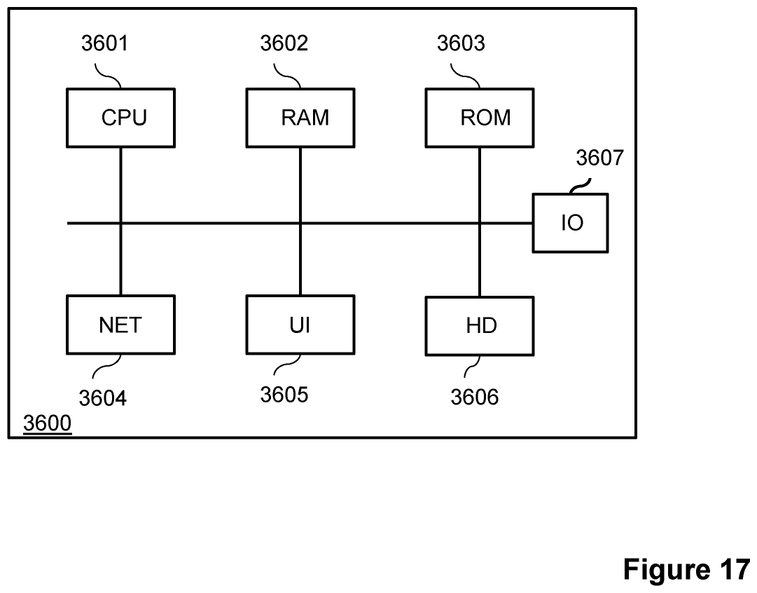

FIG. 17 is a schematic block diagram of a computing device 3600 for implementation of one or more embodiments of the invention. The computing device 3600 may be a device such as a micro-computer, a workstation or a light portable device. The computing device 3600 comprises a communication bus connected to: —a central processing unit (CPU) 3601, such as a microprocessor; —a random access memory (RAM) 3602 for storing the executable code of the method of embodiments of the invention as well as the registers adapted to record variables and parameters necessary for implementing the method for encoding or decoding at least part of an image according to embodiments of the invention, the memory capacity thereof can be expanded by an optional RAM connected to an expansion port for example; —a read only memory (ROM) 3603 for storing computer programs for implementing embodiments of the invention; —a network interface (NET) 3604 is typically connected to a communication network over which digital data to be processed are transmitted or received. The network interface (NET) 3604 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 3601; —a user interface (UI) 3605 may be used for receiving inputs from a user or to display information to a user; —a hard disk (HD) 3606 may be provided as a mass storage device; —an Input/Output module (IO) 3607 may be used for receiving/sending data from/to external devices such as a video source or display. The executable code may be stored either in the ROM 3603, on the HD 3606 or on a removable digital medium such as, for example a disk. According to a variant, the executable code of the programs can be received by means of a communication network, via the NET 3604, in order to be stored in one of the storage means of the communication device 3600, such as the HD 3606, before being executed. The CPU 3601 is adapted to control and direct the execution of the instructions or portions of software code of the program or programs according to embodiments of the invention, which instructions are stored in one of the aforementioned storage means. After powering on, the CPU 3601 is capable of executing instructions from main RAM memory 3602 relating to a software application after those instructions have been loaded from the program ROM 3603 or the HD 3606, for example. Such a software application, when executed by the CPU 3601, causes the steps of the method according to the invention to be performed.

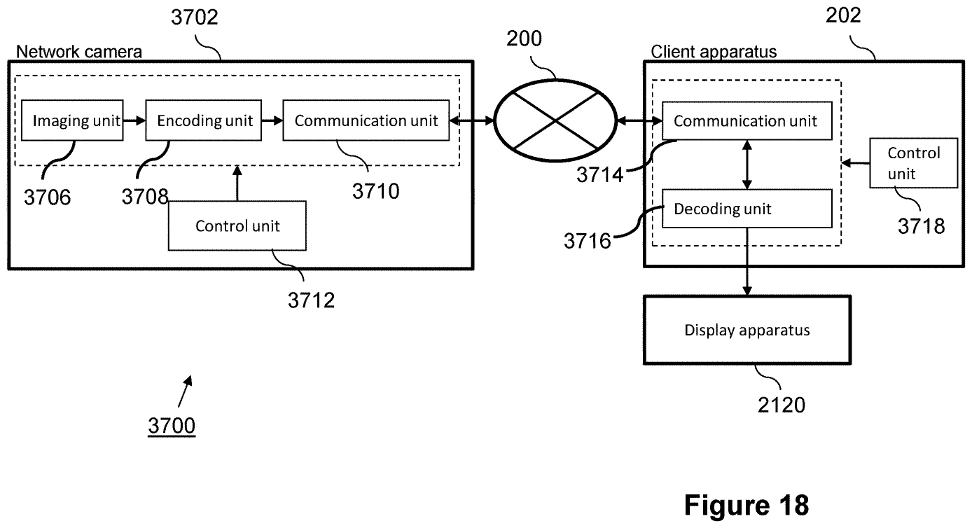

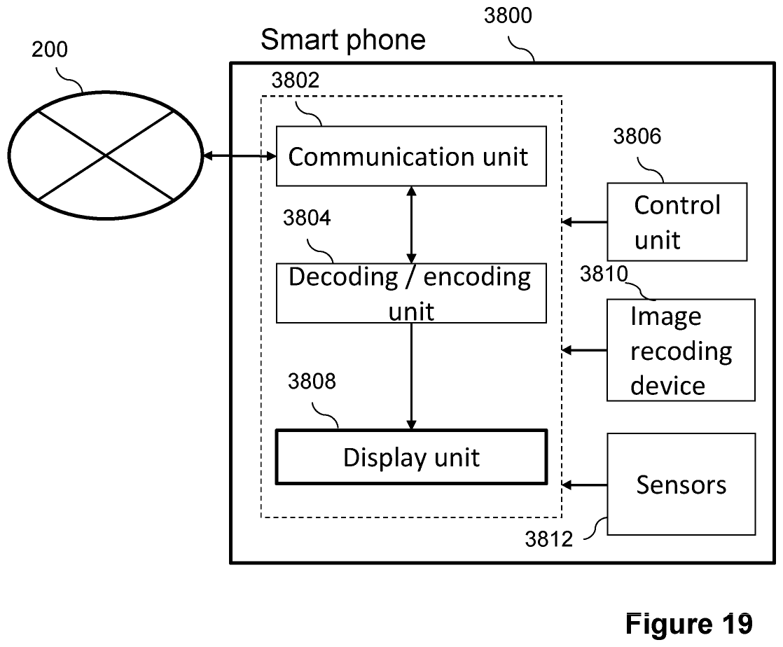

It is also understood that according to another embodiment of the present invention, a decoder according to an aforementioned embodiment is provided in a user terminal such as a computer, a mobile phone (a cellular phone), a table or any other type of a device (e.g. a display apparatus) capable of providing/displaying a content to a user. According to yet another embodiment, an encoder according to an aforementioned embodiment is provided in an image capturing apparatus which also comprises a camera, a video camera or a network camera (e.g. a closed-circuit television or video surveillance camera) which captures and provides the content for the encoder to encode. Two such examples are provided below with reference to FIGS. 18 and 19.

FIG. 18 is a diagram illustrating a network camera system 3700 including a network camera 3702 and a client apparatus 202.

The network camera 3702 includes an imaging unit 3706, an encoding unit 3708, a communication unit 3710, and a control unit 3712.

The network camera 3702 and the client apparatus 202 are mutually connected to be able to communicate with each other via the network 200.

The imaging unit 3706 includes a lens and an image sensor (e.g., a charge coupled device (CCD) or a complementary metal oxide semiconductor (CMOS)), and captures an image of an object and generates image data based on the image. This image can be a still image or a video image.

The encoding unit 3708 encodes the image data by using said encoding methods explained above. or a combination of encoding methods described above.

The communication unit 3710 of the network camera 3702 transmits the encoded image data encoded by the encoding unit 3708 to the client apparatus 202.

Further, the communication unit 3710 receives commands from client apparatus 202. The commands include commands to set parameters for the encoding of the encoding unit 3708.

The control unit 3712 controls other units in the network camera 3702 in accordance with the commands received by the communication unit 3712.

The client apparatus 202 includes a communication unit 3714, a decoding unit 3716, and a control unit 3718.

The communication unit 3714 of the client apparatus 202 transmits the commands to the network camera 3702.

Further, the communication unit 3714 of the client apparatus 202 receives the encoded image data from the network camera 3712.

The decoding unit 3716 decodes the encoded image data by using said decoding methods explained above, or a combination of the decoding methods explained above.

The control unit 3718 of the client apparatus 202 controls other units in the client apparatus 202 in accordance with the user operation or commands received by the communication unit 3714.

The control unit 3718 of the client apparatus 202 controls a display apparatus 2120 so as to display an image decoded by the decoding unit 3716.

The control unit 3718 of the client apparatus 202 also controls a display apparatus 2120 so as to display GUI (Graphical User Interface) to designate values of the parameters for the network camera 3702 includes the parameters for the encoding of the encoding unit 3708.

The control unit 3718 of the client apparatus 202 also controls other units in the client apparatus 202 in accordance with user operation input to the GUI displayed by the display apparatus 2120.

The control unit 3718 of the client apparatus 202 controls the communication unit 3714 of the client apparatus 202 so as to transmit the commands to the network camera 3702 which designate values of the parameters for the network camera 3702, in accordance with the user operation input to the GUI displayed by the display apparatus 2120.

FIG. 19 is a diagram illustrating a smart phone 3800.

The smart phone 3800 includes a communication unit 3802, a decoding unit 3804, a control unit 3806 and a display unit 3808.

the communication unit 3802 receives the encoded image data via network 200.

The decoding unit 3804 decodes the encoded image data received by the communication unit 3802.

The decoding/encoding unit 3804 decodes/encodes the encoded image data by using said decoding methods explained above.

The control unit 3806 controls other units in the smart phone 3800 in accordance with a user operation or commands received by the communication unit 3806.

For example, the control unit 3806 controls a display unit 3808 so as to display an image decoded by the decoding unit 3804. The smart phone 3800 may also comprise sensors 3812 and an image recording device 3810. In such a way, the smart phone 3800 may record images, encode the images (using a method described above).

The smart phone 3800 may subsequently decode the encoded images (using a method described above) and display them via the display unit 3808—or transmit the encoded images to another device via the communication unit 3802 and network 200.

### Alternatives and Modifications

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It is also understood that any result of comparison, determination, assessment, selection, execution, performing, or consideration described above, for example a selection made during an encoding or filtering process, may be indicated in or determinable/inferable from data in a bitstream, for example a flag or data indicative of the result, so that the indicated or determined/inferred result can be used in the processing instead of actually performing the comparison, determination, assessment, selection, execution, performing, or consideration, for example during a decoding process.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Reference numerals appearing in the claims are by way of illustration only and shall have no limiting effect on the scope of the claims.

1. A method of encoding image data into a bitstream or decoding image data from a bitstream, the bitstream including data indicating a partitioning of the image data into a plurality of blocks according to a coding tree, wherein blocks in the coding tree may be partitioned according to one or more types of split, the method comprising:
obtaining, for a current block of a frame, a parameter indicating a maximum multi-tree depth value indicating a maximum partitioning depth for a plurality of split types.

2-3. (canceled)

4. The method according to claim 1, wherein the maximum multi-tree depth value indicates the maximum partitioning depth for a binary tree split and a ternary tree split.

5. The method according to claim 1, wherein the at least one other parameter is based on a quad-tree depth of the current block or the block size of the current block.

6. (canceled)

7. The method according to claim 1, wherein the reference quad-tree depth value is signalled in a header of the bitstream.

8-9. (canceled)

10. The method according to claim 1, wherein the reference quad-tree depth value is based on an average quad-tree depth value determined from the at least one area of another frame.

11. The method according to claim 1, wherein the reference quad-tree depth value is based on a minimum quad-tree depth value determined from the at least one area of another frame.

12. The method according to claim 1, wherein the reference quad-tree depth value is based on a maximum multi-tree depth value or an average multi-tree depth value determined from at least one area of another frame.

13. The method according to claim 1, comprising increasing a current maximum multi-tree depth to obtain the maximum multi-tree depth for the current block according to one or more rules or conditions based on the quad-tree depth value and the reference depth value.

14. The method according to claim 1, comprising, when the quad-tree depth value matches the reference quad tree depth value, increasing the current maximum multi-tree depth value to obtain the maximum multi-tree depth value for the current block.

15. The method according to claim 1, comprising, when the quad-tree depth value matches the reference quad-tree depth value minus 1, increasing the current maximum multi-tree depth value to obtain the maximum multi-tree depth value for the current block.

16. The method according to claim 1, wherein it is additionally required that the reference quad-tree depth value matches a minimum quad-tree depth value associated with an area of one or more reference frames for the current maximum multi-tree depth value to be increased.

17. The method according to claim 1, wherein it is additionally required that the reference quad-tree depth value matches the maximum quad-tree depth value for the current frame for the current maximum multi-tree depth value to be increased.

18. The method according to claim 1, comprising decreasing a current maximum multi-tree depth to obtain the maximum multi-tree depth for the current block according to one or more rules or conditions based on the quad-tree depth value and the reference depth value.

19-25. (canceled)

26. The method according to claim 16, comprising, when the reference quad-tree depth value is less than the quad-tree depth value, decreasing the current maximum multi-tree depth value for the current block.

27-28. (canceled)

29. The method according to claim 1, comprising obtaining the maximum multi-tree depth value for the current block using a function of the quad-tree depth value and reference quad-tree depth value.

30. (canceled)

31. The method according to claim 1, wherein a maximum multi-tree depth value associated with one or more areas of another frame is used to obtain the maximum multi-tree depth for the current block, and wherein a condition for modifying the current maximum multi-tree depth value to obtain the maximum multi-tree depth value for the current block is based on a comparison between a maximum multi-tree depth value signaled in the bitstream and the maximum multi-tree depth value associated with one or more areas of another frame.

32. (canceled)

33. The method according to claim 1, comprising increasing a current maximum multi-tree depth value of the current block based on the maximum multi-tree depth value signalled in the bitstream being less than the maximum multi-tree depth value associated with one or more areas of another frame.

34. The method according to claim 33, wherein increasing the current maximum multi-tree depth value of the current block is dependent on the average multi-tree depth value associated with one or more areas of another frame.

35. The method according to claim 34, wherein the increase is based on a comparison between the average multi-tree depth value associated with one or more areas of another frame and the maximum multi-tree depth value signalled in the bitstream.

36. The method according to claim 35, wherein the current maximum multi-tree depth value of the current block is increased if the average multi-tree depth value associated with one or more areas of another frame is greater than or equal to half of the maximum multi-tree depth value for the current frame.

37. The method according to claim 35, wherein the current maximum multi-tree depth value of the current block is increased if the average multi-tree depth value associated with one or more areas of another frame is greater than half of the maximum multi-tree depth value for the current frame.

38. The method according to claim 36, wherein the maximum multi-tree depth value for the current frame is halved by dividing by 2.

39-40. (canceled)

41. The method according to claim 34, wherein the increase is based on a comparison between the average multi-tree depth value associated with one or more areas of another frame and the maximum multi-tree depth value of another frame.

42. The method according to claim 41, wherein the current maximum multi-tree depth value of the current block is increased if the average multi-tree depth value associated with one or more areas of another frame is greater than or equal to half of the maximum multi-tree depth value of another frame.

43. The method according to claim 41, wherein the current maximum multi-tree depth value of the current block is increased if the average multi-tree depth value associated with one or more areas of another frame is greater than half of the maximum multi-tree depth value of another frame.

44. The method according to claim 42, wherein the maximum multi-tree depth value of another frame is halved by an operation.

45-46. (canceled)

47. The method according to claim 34, wherein if the average multi-tree depth value associated with one or more areas of another frame is equal to the maximum multi-tree depth value signalled in the bitstream the current maximum multi-tree depth value of the current block is not increased.

48. The method according to claim 34, if the average multi-tree depth value associated with one or more areas of another frame is equal to the maximum multi-tree depth value of another frame the current maximum multi-tree depth value of the current block is not increased.

49. The method according to claim 34, wherein when the quad-tree depth value matches the reference quad-tree depth value the current maximum multi-tree depth of the current block is increased.

50. The method according to claim 35, wherein when the quad-tree depth value matches the reference quad-tree depth value minus 1, increasing the current maximum multi-tree depth value of the current block if the average multi-tree depth value associated with one or more areas of another frame is equal to half of the maximum multi-tree depth value for the current frame.

51. The method according to claim 35, wherein when the quad-tree depth value matches the reference quad-tree depth value minus 1, increasing the current maximum multi-tree depth value of the current block if the average multi-tree depth value associated with one or more areas of another frame is less than or equal to half of the maximum multi-tree depth value for the current frame.

52. The method according to claim 35, wherein when the quad-tree depth value matches the reference quad-tree depth value minus 1, increasing the current maximum multi-tree depth value of the current block if the average multi-tree depth value associated with one or more areas of another frame is less than half of the maximum multi-tree depth value for the current frame.

53. The method according to claim 50, wherein the maximum multi-tree depth value for the current frame is halved by an operation.

54-55. (canceled)

56. The method according to claim 41, comprising when the quad-tree depth value matches the reference quad-tree depth value minus 1, increasing the current maximum multi-tree depth value of the current block if the average multi-tree depth value associated with one or more areas of another frame is equal to half of the maximum multi-tree depth value of another frame.

57. The method according to claim 41, comprising when the quad-tree depth value matches the reference quad-tree depth value minus 1, increasing the current maximum multi-tree depth value of the current block if the average multi-tree depth value associated with one or more areas of another frame is less than or equal to half of the maximum multi-tree depth value of another frame.

58. The method according to claim 41, comprising when the quad-tree depth value matches the reference quad-tree depth value minus 1, increasing the current maximum multi-tree depth value of the current block if the average multi-tree depth value associated with one or more areas of another frame is less than half of the maximum multi-tree depth value of another frame.

59. The method according to claim 56, wherein the maximum multi-tree depth value of another frame is halved by an operation.

60-61. (canceled)

62. The method according to claim 1, comprising decreasing a current maximum multi-tree depth value of the current block based on the maximum multi-tree depth value signalled in the bitstream being greater than the maximum multi-tree depth value associated with one or more areas of another frame.

63. The method according to claim 1, comprising decreasing a current maximum multi-tree depth value of the current block when the maximum multi-tree depth signalled in the bitstream is greater than the maximum multi-tree depth value associated with one or more areas of another frame and when the current quantization parameter associated to the current block is greater than or equal to the current quantization parameter associated to one or more areas of another frame.

64. The method according to claim 1, comprising decreasing a current maximum multi-tree depth value of the current block when the maximum multi-tree depth value for the current frame matches the maximum multi-tree depth value associated with one or more areas of another frame.

65. The method according to claim 64, wherein an additional condition for the decrement of the current maximum multi-tree depth value of the current block includes that the maximum multi-tree depth value for the current frame matches the maximum multi-tree depth value of another frame.

66. The method according to claim 62, wherein an additional condition for the decrement of the current maximum multi-tree depth value to be performed includes one or more of:
i) the sequence including the current frame has a resolution higher than a predetermined resolution,
ii) the CTU size for the current block is greater than or equal to a predetermined value,
iii) the maximum multi-tree depth value for the current frame is less than the maximum quad-tree depth value of the current frame, and
iv) the maximum quad-tree depth value for the current frame is greater than a predetermined value.

67. The method according to claim 62, wherein the current maximum multi-tree depth value of the current block is further decreased if the current maximum multi-tree depth value is greater than the maximum multi-tree depth value associated with one or more areas of another frame.

68. The method according to claim 62, comprising decreasing the current maximum multi-tree depth value of the current block when the current maximum multi-tree depth value is set equal to the maximum multi-tree depth value associated with one or more areas of another frame.

69. The method according to claim 1, comprising increasing a current maximum multi-tree depth value of the current block when the maximum multi-tree depth value signalled in the bitstream is equal to the maximum multi-tree depth value associated with one or more areas of another frame.

70-130. (canceled)
